(19) United States
(12) Patent Application Publication
(10) Pub. No.: US 2019/0127519 A1
(43) Pub. Date: May 2, 2019

(54) Methods of Forming Dynamic Cross-Linked Polymer Compositions Using Functional Monomeric Chain Extenders Under Batch Process

(71) Applicant: SABIC Global Technologies B.V., Bergen Op Zoom (NL)

(72) Inventors: Husnu Alp ALIDEDEOGLU, Newburgh, IN (US); Manojkumar CHELLAMUTHU, Newburgh, IN (US); Ramon GROOTE, Oisterwijk (NL); Prashant KUMAR, Evansville, IN (US)

(21) Appl. No.: 16/095,291

(22) PCT Filed: Apr. 28, 2017
(86) PCT No.: PCT/US2017/030075

§ 371 Date: Oct. 19, 2018

Related U.S. Application Data
(60) Provisional application No. 62/328,869, filed on Apr. 28, 2016.

(51) Int. Cl. C08G 63/183; C08G 63/78; C08G 63/91

(52) U.S. Cl. CPC C08G 63/183; B01J 23/06; C08G 63/916; C08G 63/78

(57) ABSTRACT

Methods for preparing dynamic cross-linked polymer compositions derived from an ester oligomer component, a monomeric chain extender component, and transesterification and polycondensation catalysts are described.

### FIELD

The present disclosure relates to methods for preparing dynamic cross-linked polymer compositions derived from an ester oligomer component, a monomeric chain extender component, and transesterification and polycondensation catalysts.

### BACKGROUND

“Dynamic cross-linked polymer compositions” represent a versatile class of polymers. The compositions feature a system of covalently cross-linked polymer networks and can be characterized by the shifting nature of their structure. At elevated temperatures, it is believed that the cross-links undergo transesterification reactions at such a rate that a flow-like behavior can be observed. Here, the polymer can be processed much like a viscoelastic thermoplastic. At lower temperatures these dynamic cross-linked polymer compositions behave more like classical thermosets. As the rate of inter-chain transesterification slows down, the network becomes more rigid and static. The reversible nature of the network bonds allows these polymers to be heated and reheated, and reformed, as the polymers resist degradation and maintain structural integrity at high temperatures.

Previously-described methods of making a dynamic cross-linked polymer composition by combining epoxides and carboxylic acids in the presence of a transesterification catalyst required feeding all components of the polymer into a vessel which was then heated to the processing temperature of the polymer. Once all the starting components were molten, the blend was mixed. During mixing, the cross-linking reaction would take place, which led to an increase in viscosity. While this method is suitable for some small-scale operations, it is cumbersome for larger scales due to difficulties in cleaning the reaction vessels and the stirring implements. In addition, this method does not readily allow for the production of pellets or other forms of material that can be re-worked, for example, by injection molding or profile extrusion.

Further, dynamically cross-linked (DCN) poly(butylene terephthalate) (PBT) (PBT-DCN) represent a growing class of dynamically cross-linked compositions. Conventional PBT resins are semi-crystalline thermoplastics used in a variety of durable goods. PBT resins are now widely used for components in the electronics and automotive industries. Subsequently, the demand for PBT is projected to increase steadily over the coming years. Producers continue to face the challenge of meeting increasing demand for PBT while dealing with higher production costs. One approach to improving process yield and reducing cost on an industrial scale relates to using butylene terephthalate (BT)-oligomer to make PBT resins. BT-oligomer can be prepared from purified terephthalic acid and butanediol acid. To be useful in making PBT resin for specific end purposes, it is necessary to strictly control the carboxylic acid endgroup and intrinsic viscosity of the BT-oligomer.

There remains a need in the art for efficient methods of preparing dynamic cross-linked polymer compositions and a particular need for PBT dynamic cross-linked compositions.

### SUMMARY

The above-described and other deficiencies of the art are met by methods of preparing comprising: combining an ester oligomer component; a monomeric chain extender; a transesterification catalyst; and a polycondensation catalyst; at a temperature and for a time sufficient to form a molten mixture; and heating the molten mixture at a polycondensation temperature and at a polycondensation pressure for a time sufficient to initiate polycondensation and to form the dynamic cross-linked polymer composition.

Methods of preparing these polymer compositions by combining an ester oligomer component, a monomeric chain extender, a polycondensation catalyst, and a transesterification catalyst, according to a melt polycondensation process.

Articles formed from the described polymer compositions prepared according to the methods herein are also within the scope of the disclosure. Disclosed herein are methods of forming an article comprising a dynamic cross-linked polymer composition comprising preparing a dynamic cross-linked polymer composition and subjecting the dynamic cross-linked polymer composition to a conventional polymer forming process, such as compression molding, profile extrusion, injection molding, or blow molding to form the article.

The above described and other features are exemplified by the following drawings, detailed description, examples, and claims.

### BRIEF DESCRIPTION OF THE DRAWINGS

The following is a brief description of the drawings wherein like elements are numbered alike and which are exemplary of the various aspects described herein.

FIG. 1 depicts the storage (solid line) and loss (dashed line) modulus of the oscillatory time sweep measurement curves for a cross-linking polymer network.

FIG. 2 depicts the normalized modulus (G/G₀) for the dynamically cross-linked polymer network (solid line), as well as a line representing the absence of stress relaxation in a conventional cross-linked polymer network (dashed line, fictive data).

FIG. 3 depicts the batch results for the intrinsic viscosities of dynamically cross-linked polybutylenes (PBT-DCNs) at various loadings of Pyromellitic Dianhydride (PMDA) during esterification and polycondensation.

FIG. 4 depicts the stress relaxation curves of PBT-DCN at 1.2 wt. % PMDA cross-linking agent at 230° C. to 290° C. See, e.g., Table 3.

FIG. 5 depicts the Arrhenius plot showing temperature dependence of characteristic relaxation time τ* for sample prepared with 1.2 wt. % PMDA.

FIG. 6 depicts the stress relaxation curves of PBT-DCN at 2.5 wt. % PMDA cross-linking agent at 250° C. and 270° C. See, e.g., Table 3.

FIG. 7 depicts the intrinsic viscosities observed during polycondensation step for PBT-DCNs with various loadings of bisphenol A (BPA) epoxy and 3,4-epoxy cyclohexyl methyl-3,4-epoxy cyclohexyl carboxylate (ERL) epoxy cross-linking agent and/or chain extender. See, e.g., Table 4.

FIG. 8 depicts the intrinsic viscosities observed during polycondensation step for PBT-DCNs at 1.25 wt. % and 2.5 wt. % of BPA epoxy and ERL epoxy cross-linking agent and/or chain extender.

FIG. 9 depicts the normalized stress relaxation modulus as a function of time for the dynamically cross-linked networks synthesized via BT-oligomers with 2.5 wt. % of BPA epoxy cross-linking agent and/or chain extender.

FIG. 10 depicts the Arrhenius plot showing temperature dependence of characteristic relaxation time τ* for sample prepared with 2.5 wt. % BPA epoxy chain extender or cross-linking agent.

FIG. 11 depicts the normalized stress relaxation modulus as a function of time for the compositions prepared via BT oligomers with 2.5 wt. % of the BPA epoxy cross-linking agent and/or chain extender.

FIG. 12 depicts the normalized stress relaxation modulus as a function of time for the dynamically cross-linked networks prepared via BT oligomers with 2.5 wt. % of the ERL epoxy cross-linking agent and/or chain extender.

FIG. 13 depicts the Arrhenius plot showing temperature dependence of characteristic relaxation time τ* for sample prepared with 2.5 wt. % ERL epoxy.

FIG. 14 depicts the normalized stress relaxation modulus as a function of time for a post-cured composition prepared with 2.5 wt. % BPA epoxy cross-linker at a 30 minute oscillatory time sweep.

FIG. 15 depicts the normalized stress relaxation modulus as a function of time for a post-cured composition prepared with 2.5 wt. % ERL epoxy cross-linker at a 30 minute oscillatory time sweep.

### DETAILED DESCRIPTION OF ILLUSTRATIVE EMBODIMENTS

The present disclosure may be understood more readily by reference to the following detailed description of desired aspects and the examples included therein. In the following specification and the claims that follow, reference will be made to a number of terms which have the following meanings.

Described herein are methods of making compositions, i.e., dynamic cross-linked polymer compositions. These compositions are advantageous because they can be prepared more readily than dynamic cross-linkable polymer compositions previously described in the art.

### Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Numerical values in the specification and claims of this application, particularly as they relate to polymers or polymer compositions, oligomers or oligomer compositions, reflect average values for a composition that may contain individual polymers or oligomers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

As used herein the terms “weight percent” and “wt. %,” which can be used interchangeably, indicate the percent by weight of a given component based on the total weight of the composition, unless otherwise specified. That is, unless otherwise specified, all wt. values are based on the total weight of the composition. It should be understood that the sum of wt. % values for all components in a disclosed composition or formulation are equal to 100,

As used herein, “Tₘ” refers to the melting point at which a polymer, or oligomer, completely loses its orderly arrangement.

As used herein, “T_{c}” refers to the crystallization temperature at which a polymer gives off heat to break a crystalline arrangement.

The terms “Glass Transition Temperature” or “T_{g}” refer to the maximum temperature at which a polymer will still have one or more useful properties. These properties include impact resistance, stiffness, strength, and shape retention. The T_{g} therefore may be an indicator of its useful upper temperature limit, particularly in plastics applications. The T_{g} may be measured using a differential scanning calorimetry method and expressed in degrees Celsius.

As used herein, the terms “terephthalic acid group” and “isophthalic acid group” (“diacid groups”) “butanediol group,” “alcohol group,” “aldehyde group,” and “carboxylic acid group,” being used to indicate, for example, the weight percent of the group in a molecule, the term “isophthalic acid group(s)” means the group or residue of isophthalic acid having the formula (—O(CO)C6H4(CO)—), the term “terephthalic acid group” means the group or residue of isophthalic acid having the formula (—O(CO)C6H4(CO)—), the term “butanediol group” means the group or residue of butanediol having the formula (—O(C4H8)—), the term “alcohol group” means the group or residue of hydroxide having the formula (—O(OH)—), the term “aldehyde group” means the group or residue of an aldehyde having the formula (—O(CHO)—), and the term “carboxylic acid group” means the group or residue of a carboxylic acid having the formula (—O(COOH)—).

As used herein, “cross-link,” and its variants, refer to the formation of a stable covalent bond between two polymers. This term is intended to encompass the formation of covalent bonds that result in network formation, or the formation of covalent bonds that result in chain extension. The term “cross-linkable” refers to the ability of a polymer to form such stable covalent bonds.

As used herein, a quencher refers to a substance or compound that may be used to stop or diminish performance of the polycondensation or transesterification catalyst. In certain aspects of the present disclosure, a quencher is not added in the formation of the dynamic cross-linking composition.

As used herein, “dynamic cross-linked polymer composition” refers to a class of polymer systems that include dynamically, covalently cross-linked polymer networks. At low temperatures, dynamic cross-linked polymer compositions behave like classic thermosets, but at higher temperatures, for example, temperatures up to about 320° C., it is theorized that the cross-links have dynamic mobility, resulting in a flow-like behavior that enables the composition to be processed and re-processed. Dynamic cross-linked polymer compositions incorporate covalently cross-linked networks that are able to change their topology through thermoactivated bond exchange reactions. The network is capable of reorganizing itself without altering the number of cross-links between its atoms. At high temperatures, dynamic cross-linked polymer compositions achieve transesterification rates that permit mobility between cross-links, so that the network behaves like a flexible rubber. At low temperatures, exchange reactions are very long and dynamic cross-linked polymer compositions behave like classical thermosets. The transition from the liquid to the solid is reversible and exhibits a glass transition. Put another way, dynamic cross-linked polymer compositions can be heated to temperatures such that they become liquid without suffering destruction or degradation of their structure. The viscosity of these materials varies slowly over a broad temperature range, with behavior that approaches the Arrhenius law. Because of the presence of the cross-links, a dynamic cross-linked polymer composition will not lose integrity above the T_{g} or Tₘ like a thermoplastic resin will. The cross-links are capable of rearranging themselves via bond exchange reactions between multiple cross-links and/or chain segments as described, for example, by Kloxin and Bowman, Chem. Soc. Rev. 2013, 42, 7161-7173. The continuous rearrangement reactions may occur at room or elevated temperatures depending upon the dynamic covalent chemistry applicable to the system. The respective degree of cross-linking may depend on temperature and stoichiometry. Dynamic cross-linked polymer compositions of the disclosure can have T_{g} of about 40° C. to about 60° C. An article made from a dynamic cross-linked polymer composition can be heated and deformed, and upon returning to the original temperature, maintains the deformed shape. As such, articles in accordance with the present disclosure may comprises a shape generated by applying mechanical forces to a molded piece formed from the dynamic cross-linked polymer composition. This combination of properties permits the manufacture of shapes that are difficult or impossible to obtain by molding or for which making a mold would not be economical. Dynamic cross-linked polymer compositions generally have good mechanical strength at low temperatures, high chemical resistance, and low coefficient of thermal expansion, along with processability at high temperatures. Examples of dynamic cross-linked polymer compositions are described herein, as well as in U.S. Patent Application No. 2011/0319524, WO 2012/152859; WO 2014/086974; D. Montarnal et al., Science 334 (2011) 965-968; and J. P. Brutman et al, ACS Macro Lett. 2014, 3, 607-610. As an example, articles may be formed from the dynamic cross-linked polymer compositions of the present disclosure and may include composites, a thermoformed material, or a combination thereof. The articles may further comprise a solder bonded to the formed article.

Examining the nature of a given polymer composition can distinguish whether the composition is cross-linked, reversibly cross-linked, or non-cross-linked, and distinguish whether the composition is conventionally cross-linked or dynamically cross-linked. Dynamically cross-linked networks feature bond exchange reactions proceeding through an associative mechanism, while reversible cross-linked networks feature a dissociative mechanism. That is, the dynamically cross-linked composition remains cross-linked at all times, provided the chemical equilibrium allowing cross-linking is maintained. A reversibly cross-linked network however shows network dissociation upon heating, reversibly transforming to a low-viscous liquid and then reforming the cross-linked network upon cooling. Reversibly cross-linked compositions also tend to dissociate in solvents, particularly polar solvents, while dynamically cross-linked compositions tend to swell in solvents as do conventionally cross-linked compositions.

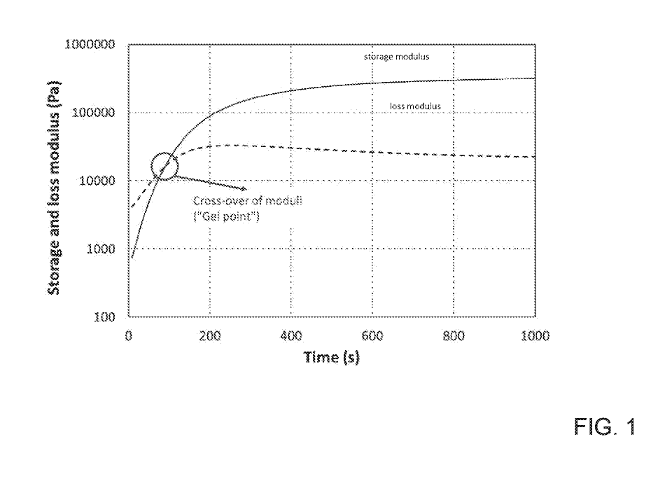

The cross-linked network apparent in dynamic and other conventional cross-linked systems may also be identified by rheological testing. An oscillatory time sweep (OTS) measurement at fixed strain and temperature may be used to confirm network formation. Exemplary OTS curves are presented in FIG. 1 for a cross-linking polymer network.

The evolution of the curves indicates whether or not the polymer has a cross-linked network. Initially, the loss modulus (viscous component) has a greater value than the storage modulus (elastic component) indicating that the material behaves like a viscous liquid. Polymer network formation is evidenced by the intersection of the loss and storage modulus curves. The intersection, referred to as the “gel point,” represents when the elastic component predominates the viscous component and the polymer begins to behave like an elastic solid.

In distinguishing between dynamic cross-linking and conventional (or non-reversible) cross-linking, a stress relaxation measurement may also, or alternatively, be performed at constant strain and temperature.

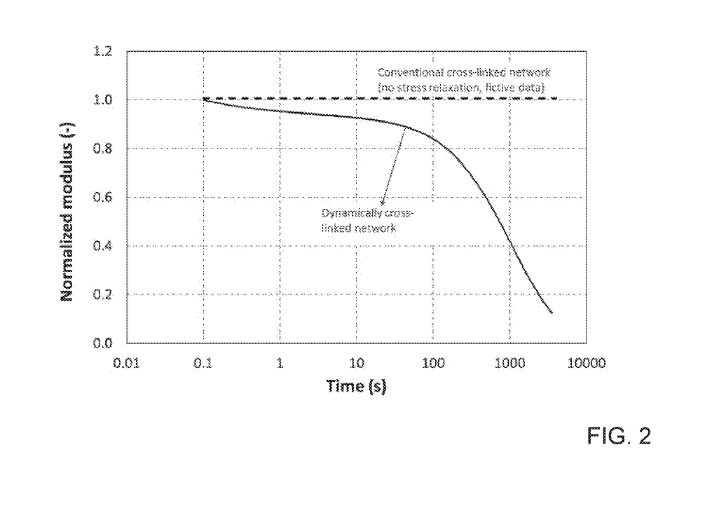

After network formation, the polymer may be heated and certain strain imposed on the polymer. The resulting evolution of the elastic modulus as a function of time reveals whether the polymer is dynamically or conventionally cross-linked. Exemplary curves for dynamically and conventionally cross-linked polymer networks are presented in FIG. 2.

Stress relaxation generally follows a multimodal behavior:

$$G / {G}_{0} = {\sum }_{i = 1}^{n} {C}_{i} exp ( - t / {τ}_{i} ) ,$$

where the number (n), relative contribution (Cᵢ) and characteristic timescales (τᵢ) of the different relaxation modes are governed by bond exchange chemistry, network topology and network density. For a conventional cross-linked networks, relaxation times approach infinity, τ→∞, and G/G₀=1 (horizontal dashed line). Apparent in the curves for the normalized modulus (G/G₀) as a function of time, a conventionally cross-linked network does not exhibit any stress relaxation because the permanent character of the cross-links prevents the polymer chain segments from moving with respect to one another. A dynamically cross-linked network, however, features bond exchange reactions allowing for individual movement of polymer chain segments thereby allowing for complete stress relaxation over time.

If the networks are DCN, they should be able to relax any residual stress that is imposed on the material as a result of network rearrangement at higher temperature. The relaxation of residual stresses with time can be described with single-exponential decay function, having only one characteristic relaxation time τ*:

$$G ( t ) = G ( 0 ) \times exp ( - \frac{t}{{τ}^{*}} )$$

A characteristic relaxation time can be defined as the time needed to attain particular G(t)/G(0) at a given temperature. At lower temperature, stress relaxes slower, while at elevated temperature network rearrangement becomes more active and hence stress relaxes faster, proving the dynamic nature of the network. The influence of temperature on stress relaxation modulus clearly demonstrates the ability of cross-linked network to relieve stress or flow as a function of temperature.

Additionally, the influence of temperature on the stress relaxation rate in correspondence with transesterification rate were investigated by fitting the characteristic relaxation time, τ* to an Arrhenius type equation.

ln τ*=−Eₐ/RT+ln A

where Eₐ is the activation energy for the transesterification reaction.

Described herein are methods of preparing dynamic cross-linked polymer compositions via a melt polycondensation reaction. According to these methods, an ester oligomer component, a monomeric chain extender, a transesterification catalyst, and a polycondensation catalyst may be combined at atmospheric pressure at a temperature of up to about 260° C. for about 40 minutes or less until the foregoing components form a molten mixture. The resulting resultant molten mixture may undergo polycondensation under an inert atmosphere and a reduced vacuum pressure of less than 1 mm Hg for a polycondensation residence time of up to about 90 minutes.

In preferred aspects, the combining of the ester oligomer component, the monomeric chain extender, the transesterification catalyst, and the polycondensation catalyst occurs for less than about 60 minutes to form the molten mixture. In other aspects, the combining to form the molten mixture occurs for less than about 40 minutes. In yet other aspects, the combining to form the molten mixture occurs for less than about 30 minutes. In still other aspects, the combining to form the molten mixture occurs for between about 20 minutes and 30 minutes.

In various aspects of the present disclosure, the combining step at a temperature to provide a molten mixture occurs at a temperature sufficient to form a homogenous melt of the ester oligomer component. Thus, the combining step to provide a molten mixture may occur at or about a melting temperature of the ester oligomer component.

In some aspects, the combining step to provide a molten mixture occurs at temperatures of up to about 290° C. In yet other aspects, the melt combining step occurs at temperatures of between about 40° C. and about 290° C. In other aspects, the combining step occurs at temperatures of between about 40° C. and about 270° C. In some aspects, the combining step occurs at temperatures of between about 40° C. and about 260° C. In yet other aspects, the combining step occurs at temperatures of between about 70° C. and about 290° C. In still other aspects, the combining step occurs at temperatures of between about 190° C. and about 290° C. In other aspects, the combining step occurs at temperatures of between about 190° C. and about 240° C.

In various aspects of the present disclosure, the combining step occurs at a temperature less than the temperature of degradation of the respective ester oligomer component. As an example, the combining step occurs at a temperature less than or about equal to the Tₘ of the respective ester oligomer. In one example, the combining step occurs at about 240° C. to 260° C., below the degradation temperature of BT-oligomer.

The combining step to provide a molten mixture can be achieved using any means known in the art, for example, mixing, blending, stirring, shaking, and the like in a reactor or vessel equipped with an appropriate heat source. A preferred method combining the ester oligomer component, the monomeric chain extender, the transesterification catalyst, and the polycondensation catalyst to provide a molten mixture is to use a melt reactor. As an example, a melt reactor or vessel can be charged with the foregoing components.

In various aspects of the present disclosure, the obtained molten mixture is heated to enable a polycondensation reaction to occur, and heating is carried out at a temperature (a “polycondensation temperature”) and at a pressure (a “polycondensation pressure”) sufficient and for a time sufficient to provide a dynamically cross-linked composition. In some aspects, the polycondensation reaction occurs at temperatures of up to about 260° C. In some aspects, the polycondensation occurs at temperatures of between about 40° C. and about 260° C. In other aspects, the polycondensation occurs at temperatures of between about 40° C. and about 250° C.

In some aspects, the polycondensation occurs at temperatures of between about 40° C. and about 240° C. In yet other aspects, the polycondensation occurs at temperatures of between about 70° C. and about 260° C. In yet other aspects, the polycondensation occurs at temperatures of between about 190° C. and about 260° C. In still other aspects, the polycondensation occurs at temperatures of between about 190° C. and about 250° C. In other aspects, the polycondensation occurs at temperatures of between about 190° C. and about 240° C.

In some aspects of the present disclosure, the polycondensation occurs at a temperature less than the temperature of degradation of the respective ester oligomer component. As an example, the polycondensation occurs at a temperature less than or about equal to the Tₘ of the respective ester oligomer. In one example, where the ester oligomer is BT-oligomer the polycondensation step occurs at about 240° C. to 260° C., below the degradation temperature of BT-oligomer.

The heating the molten mixture at a polycondensation temperature occurs at a sufficient pressure to provide a dynamically cross-linked composition. In some aspects, the polycondensation reaction occurs at a pressure of less than 1 mm Hg, preferably between about 0.5 mmHg and 1 mm Hg. In yet other aspects, the polycondensation reaction occurs at a pressure between 0.6 mm Hg and 1 mm Hg. In still other aspects, the polycondensation reaction occurs between 0.7 mm Hg and 1 mm Hg.

In yet further aspects of the present disclosure, the molten mixture is heated at a polycondensation temperature and at a polycondensation pressure for a time sufficient to initiate polycondensation and to form the dynamic cross-linked polymer composition. The molten mixture undergoes a polycondensation reaction for a sufficient residence time as the desired temperature and decreased pressure. In an aspect, the polycondensation residence time can be up to about 90 minutes. In other aspects, the polycondensation residence time occurs for up to about 80 minutes. In yet other aspects, the polycondensation residence time occurs for up to about 70 minutes. In still other aspects, the polycondensation residence time occurs for between about 30 minutes and about 80 minutes. In preferred aspects, the polycondensation reaction of the molten mixture occurs for about 65 minutes to form the dynamic cross-linked polymer composition.

In an aspect, a continuously stirred or agitated melt tank or melt reactor for heating the ester oligomer and a series of one or more reactors for polycondensation of the molten mixture may be used. In further aspects, a continuously stirred melt reactor may be used for the combining step and the polycondensation process step. The components of an industrial processor are readily known to the skilled practitioner. For example, the melt tank for melting the ester oligomer can be selected from the group consisting of a melt tank reactor, a melt tank extruder with or without internal screw conveying, and a conveying melt tube. The reactor for post condensation processing is ideally a reactor that can be operated at steady state and where the temperature and concentration are identical everywhere within the reactor as well as at the exit point. A commonly used reactor is a continuous stirred tank reactor (CSTR).

As an exemplary process, prepared ester oligomers may be flaked, powdered, or pelletized into a continuously stirred reactor where the ester oligomer is heated to between 220° C. and 250° C. to achieve a flowable melt. The melt process occurs at atmospheric pressure and may proceed under an inert atmosphere. Heating of the reactor may be achieved according to a number of well-known methods in the art. For example, heating may be achieved using an oil bath. The transesterification and polycondensation catalysts and chain extenders may be introduced to the reactor. After a residence time to ensure complete molten formation of the contents of the reactor, the temperature is increased to between 250° C. and 260° C. The melt residence time can be up to about 30 minutes. The pressure is reduced to less than about 1 mmHg for a residence time sufficient for polycondensation to occur for the formation of the dynamically cross-linked network. The polycondensation residence time can be up to about 70 minutes.

The methods described herein can be carried out under ambient atmospheric conditions, but it is preferred that the methods be carried out under an inert atmosphere, for example, a nitrogen atmosphere. Preferably, the methods are carried out under conditions that reduce the amount of moisture in the resulting dynamic cross-linked polymer compositions described herein. For example, preferred dynamic cross-linked polymer compositions described herein will have less than about 3.0 wt. %, less than about 2.5 wt. %, less than about 2.0 wt. %, less than about 1.5 wt. %, or less than about 1.0 wt. % of water (i.e., moisture), based on the weight of the dynamic cross-linked polymer composition.

In some methods, the combination of the ester oligomer component, the monomeric chain extender, the transesterification catalyst, and the polycondensation catalyst can be carried out at atmospheric pressure. In other aspects, the combining step can be carried out at a pressure that is less than atmospheric pressure. For example, in some aspects, the combination of ester oligomer component, the monomeric chain extender, the transesterification catalyst, and the polycondensation catalyst is carried out in a vacuum.

The compositions of the present disclosure provide dynamically cross-linked compositions exhibiting the characteristic stress-relaxation behavior associated with formation of a dynamic network. In certain aspects of the present disclosure, to achieve a fully cured, dynamic cross-linked composition, compositions prepared herein undergo a post-curing step. The post-curing step may include heating the obtained composition to elevated temperatures for a prolonged period. The composition may be heated to a temperature just below the melt or deformation temperature. Heating to just below the melt or deformation temperature activates the dynamically cross-linked network, thereby, curing the composition to a dynamic cross-linked polymer composition. As an example, a composition prepared with an epoxy such as ERL®-4221 (3,4-epoxy cyclohexyl methyl-3,4-epoxy cyclohexyl carboxylate).

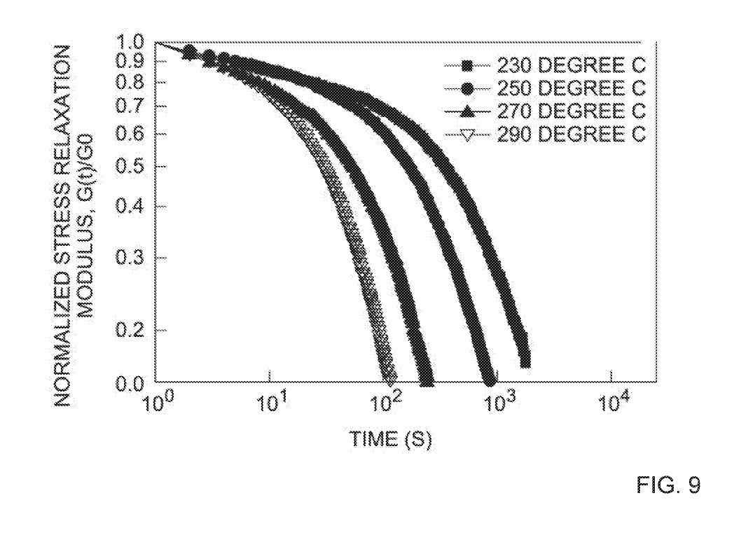

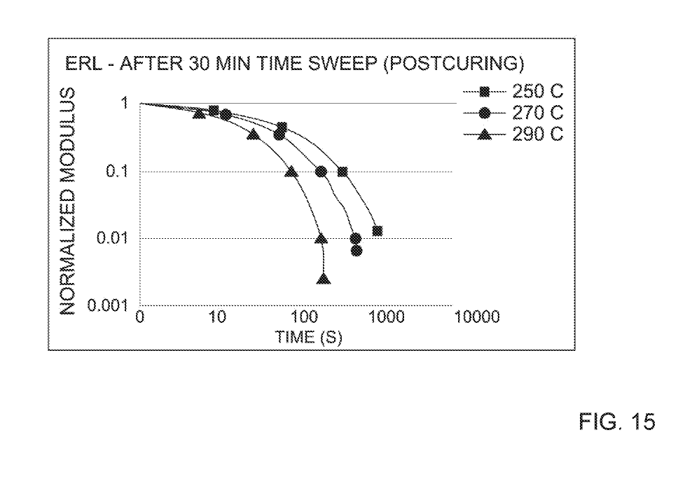

A post-curing step may be necessary to activate the dynamic cross-linked network in certain compositions of the present disclosure. Certain chain extenders or cross-linking agents may require that a post-curing step is performed to facilitate the formation of the dynamically cross-linked network. For example, a post-curing step may be needed for a composition prepared with a less reactive chain extender or cross-linking agent. Less reactive chain extenders or cross-linking agents may include epoxy chain extenders that generate secondary alcohols in the presence of a suitable catalyst. To initiate the dynamically cross-linked network in a composition prepared with ERL epoxy, for example, the composition may be post-cured by heating for a sufficient period of time. In one example, the composition prepared from an ERL epoxy is heated at 250° C. for about 30 minutes. See, e.g., FIG. 15. In yet further aspects of the present disclosure, certain compositions exhibit dynamically cross-linked network formation after a shorter post-curing step. As an example, a dynamically cross-linked network may be formed throughout a composition prepared with BPA epoxy after a post-curing step of about 5 minutes at 250° C. See, e.g., FIG. 9. In yet further aspects, compositions assume a dynamically cross-linked network formation and need not undergo a post-curing step. That is, these compositions do not require additional heating to achieve the dynamically cross-linked network. In some aspects, compositions derived from more reactive chain extenders exhibit dynamically cross-linked network behavior without heating. More reactive chain extenders can include epoxy chain extenders that generate primary alcohols in the presence of a suitable catalyst.

As provided above, a post-curing step may be necessary to activate the dynamic cross-linking network in certain compositions of the present disclosure. These compositions may be referred to as pre-dynamic cross-linking compositions and may be cured according to any of the above post-curing steps, among others. In further examples, such pre-dynamic cross-linking polymer compositions may also be transformed into dynamic cross-linked polymer composition articles using existing processing or shaping processes such as, for example, injection molding, compression molding, profile extrusion, blow molding, and the like, given that the residence times of the processes are in the order of the reaction times of the dynamic cross-linked polymer composition formation. For example, pre-dynamic cross-linked polymer compositions prepared according to the described methods can be melted and then injected into an injection mold to form an injection-molded article. The injection-molding process can provide the cured article by mold heating to temperatures of up to about 320° C., followed by cooling to ambient temperature. In other methods, a pre-dynamic cross-linked polymer composition can be melted, subjected to compression molding processes to activate the cross-linking system to form a dynamic cross-linked polymer composition.

Dynamic cross-linked polymer compositions prepared according to the methods described herein can be formed into any shape known in the art. Such shapes can be convenient for transporting the dynamic cross-linked polymer compositions described herein. Alternatively, the shapes can be useful in the further processing of the dynamic cross-linked polymer compositions described herein into dynamic cross-linked polymer compositions and articles comprising them. For example, the dynamic cross-linked polymer compositions can be formed into pellets. In other aspects, the dynamic cross-linked polymer compositions can be formed into flakes. In yet other aspects, the dynamic cross-linked polymer compositions can be formed into powders.

The dynamic cross-linked polymer compositions described herein can be use in conventional polymer forming processes such as, for example, injection molding, compression molding, profile extrusion, blow molding, etc. For example, the dynamic cross-linked polymer compositions prepared according to the described methods can be melted and then injected into an injection mold to form an injection-molded article. The injection-molded article can then be cured by heating to temperatures of up to about 320° C., followed by cooling to ambient temperature. As an example, articles may be formed from the dynamic cross-linked polymer compositions of the present disclosure and may include composites, a thermoformed material, or a combination thereof. The articles may further comprise a solder bonded to the formed article.

Alternatively, the dynamic cross-linked polymer compositions described herein can be melted, subjected to compression molding processes, and then cured. In other aspects, the dynamic cross-linked polymer compositions described herein can be melted, subjected to profile extrusion processes, and then cured. In some aspects, the dynamic cross-linked polymer compositions described herein can be melted, subjected to blow molding processes, and then cured. The individual components of the dynamic cross-linked polymer compositions are described in more detail herein.

### Ester Oligomer Component

Present in the compositions described herein are oligomers that have ester linkages. The oligomer can contain only ester linkages between monomers. The oligomer can also contain ester linkages and potentially other linkages as well.

In some aspects, the oligomer component can comprise oligomers containing ethylene terephthalate groups, oligomers containing ethylene isophthalate groups, oligomers containing diethylene terephthalate groups, oligomers containing diethylene isophthalate groups, oligomers containing butylene terephthalate groups, oligomers containing butylene isophthalate groups, and covalently bonded oligomeric groups containing at least two of the foregoing groups.

In a preferred aspect, the oligomer can comprise an oligomer having “n” the degree of polymerization and represents the number of units of butylene terephthalate groups. The oligomer having ester linkages can be an alkylene terephthalate, for example, an oligomer containing butylene terephthalate, described herein as BT-oligomer, which has the structure shown below:

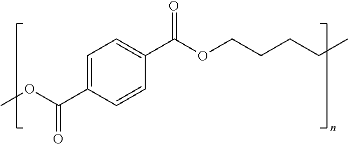

where n is the degree of polymerization, and can have a value between 1 and 15. The oligomer may have an intrinsic viscosity between 0.09 dl/g and 0.35 dl/g. The oligomer having ester linkages can be an oligomer containing ethylene terephthalate (ET), described herein as an ET-oligomer, which has the structure shown below:

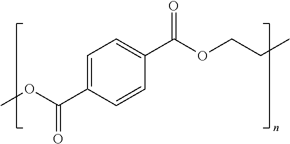

where n is the degree of polymerization, and can have a value between 1 and 15. The ethylene terephthalate oligomer may have an intrinsic viscosity between 0.09 dl/g and 0.35 dl/g.

The polymer having ester linkages can be a CTG-oligomer, which refers to an oligomer containing (cyclohexylenedimethylene terephthalate), glycol-modified groups. The oligomer is a copolymer formed from 1,4-cyclohexanedimethanol (CHDM), ethylene glycol, and terephthalic acid. The two diols react with the diacid to form a copolyester. The resulting copolyester has the structure shown below:

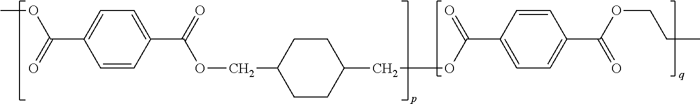

where p is the molar percentage of repeating units derived from CHDM, q is the molar percentage of repeating units derived from ethylene glycol, and p>q. The CTG-oligomer may have an intrinsic viscosity between 0.09 dl/g and 0.35 dl/g. The oligomer having ester linkages can also be ETG-oligomer. ETG-oligomer has the same structure as CTG-oligomer, except that the ethylene glycol is 50 mole % or more of the diol content. ETG-oligomer is an abbreviation for an oligomer containing ethylene terephthalate, glycol-modified. The oligomer having ester linkages can contain 1,4-cyclohexane-dimethanol-1,4-cyclohexanedicarboxylate units, having the structure shown below:

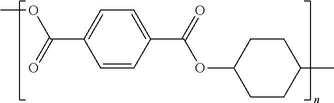

where n is the degree of polymerization, and can have a value between 1 and 15. The oligomer having ester linkages can contain 1,4-cyclohexane-dimethanol-1,4-cyclohexanedicarboxylate units may have an intrinsic viscosity between 0.09 dl/g and 0.35 dl/g.

The oligomer having ester linkages can contain ethylene naphthalate units and have the structure shown below:

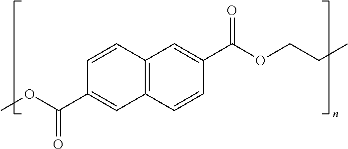

where n is the degree of polymerization, and can have a value between 1 and 15. The oligomer may have an intrinsic viscosity between 0.09 dl/g and 0.35 dl/g.

Aliphatic esters can also be used as the oligomers described herein. Examples of aliphatic esters include esters having repeating units of the following formula:

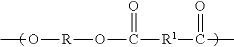

where at least one R or R¹ is an alkyl-containing radical. They are prepared from the polycondensation of glycol and aliphatic dicarboxylic acids. The aliphatic ester oligomer may have an intrinsic viscosity between 0.09 dl/g and 0.35 dl/g.

The oligomer having ester linkages can also include ester carbonate linkages. The ester carbonate linkages contains two sets of repeating units, one having carbonate linkages and the other having ester linkages. This is illustrated in the structure below:

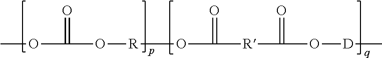

where p is the molar percentage of repeating units having carbonate linkages, q is the molar percentage of repeating units having ester linkages, and p+q=100%; and R, R′, and D are independently divalent radicals.

In various aspects of the present disclosure, the ester oligomer can have an intrinsic viscosity between 0.09 deciliters per gram (dl/g) and 0.35 dl/g. An intrinsic viscosity between 0.09 dl/g and 0.35 dl/g can correspond to an average molecular weight of between 1000 and 3500. Further, the ester oligomer can have a particular carboxylic acid endgroup concentration (CEG). In some aspects, the ester oligomer can have a carboxylic acid endgroup concentration between about 20 and 120 millimole per kilogram (mmol/kg).

In one aspect, the preferred oligomer is an ester containing butylene terephthalate, referred to herein as a (butylene terephthalate) oligomer or BT-oligomer. The BT-oligomer can have an intrinsic viscosity between 0.09 dl/g and 0.35 dl/g. In a preferred aspect, the BT-oligomer can have an intrinsic viscosity of about 0.11 deciliters per gram. The BT-oligomer can have a carboxylic acid endgroup concentration between 20 mmol/kg and 120 mmol/kg. As an example, the BT-oligomer can have a carboxylic acid endgroup concentration of about 100 millimol per kilogram (mmol/kg).

In some aspects, the BT-oligomer can be derived from purified terephthalic acid. As an example, the BT oligomer may be prepared from a batch polycondensation process comprising combining a portion of butanediol (BDO) acid pre-heated to about 100° C. with purified terephthalic acid in a reaction vessel to provide a first mixture, and heating the mixture to between 240° C. and 260° C. At about 170° C., a polycondensation catalyst such as titanium(IV) isopropoxide (TPT) can be mixed with a portion of BDO and introduced to the reaction vessel. The reaction vessel can be equipped with a column and condenser to direct condensate away from the reaction vessel. At the desired melt temperature of the BT-oligomers (at about 248° C. to 250° C.), the temperature is maintained and samples of the reaction vessel contents can be evaluated for the desired IV and CEG. The resultant BT-oligomer can be cooled and pelletized, or flaked, and ground to a fine powder to facilitate in even melting of the BT-oligomer for preparation of the dynamically cross-linked composition.

The compositions of the present disclosure include an ester oligomer component. The ester oligomer component is present in an amount between 90 wt. % and 95 wt. %.

### Chain Extender/Cross-linking Agent Component

The compositions of the present disclosure include a chain extender or a cross-linking agent. The chain extender, or cross-linking agent, of the present disclosure can be a monomeric compound. In an aspect, the monomeric chain extender can be functional, that is, the monomeric chain extender may exhibit reactivity with one or more groups of a given chemical structure. As an example, the monomeric chain extenders described herein may be characterized by one of two reactivities with groups present within the ester oligomer component. The monomeric chain extender may react with 1) the carboxylic acid endgroup moiety or 2) the alcohol endgroup moiety of the ester oligomer component.

Useful monomeric chain extenders exhibiting reactivity with the carboxylic groups of the ester oligomer include epoxy based chain extenders. Various epoxy chain extenders or cross-linking agent and their feed amount may largely affect the networks' property by affecting the cross-linking density and transesterification dynamic. The epoxy moiety of the monomeric chain extender may directly react with the carboxylic acid endgroup of the ester oligomer in the presence of the transesterification catalyst. In an aspect, the epoxy-containing chain extender may be multi-functional, that is having at least two epoxy groups. The epoxy-chain extender generally has at least two epoxy groups, and can also include other functional groups as desired, for example, hydroxyl (—OH). Glycidyl epoxy resins are a particularly preferred epoxy-containing component.

Exemplary epoxy based chain extenders include a BPA epoxy shown in Formula A (bisphenol A diglycidyl ether, BADGE) and a cycloaliphatic epoxide resin, such as ERL epoxy (3,4-epoxy cyclohexyl methyl-3,4-epoxy cyclohexyl carboxylate), shown in Formula B.

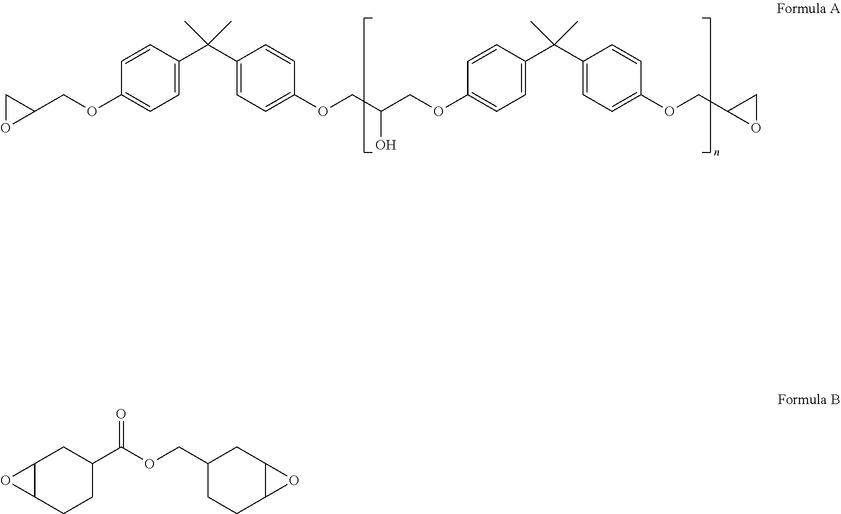

For a monomeric bisphenol A epoxy, the value of n is 0 in Formula (A). When n=0, this is a monomer. BADGE-based resins have excellent electrical properties, low shrinkage, good adhesion to numerous metals, good moisture resistance, good heat resistance and good resistance to mechanical impacts. In some aspects of the present disclosure, the BADGE has a molecular weight of about 1000 Daltons and an epoxy equivalent of about 530 g per equivalent. As used herein, the epoxy equivalent is an expression of the epoxide content of a given compound. The epoxy equivalent is the number of epoxide equivalents in 1 g of resin (eq./g).

Preferred epoxy chain extenders of the present disclosure include monomeric epoxy compounds which generate a primary alcohol. In the presence of a suitable catalyst, the generated primary alcohol can readily undergo transesterification. As an example, and not to be limiting, exemplary epoxy chain extenders that generate a primary alcohol include certain cyclic epoxies. Exemplary cyclic epoxies that generate a primary alcohol in the presence of a suitable catalyst have a structure according to Formula C.

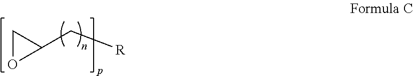

where n is greater than or equal to 1 and R can be any chemical group (including, but not limited to, ether, ester, phenyl, alkyl, alkyne, etc.). In preferred aspects of the present disclosure, p is greater than or equal to 2 such that there are at least 2 of the epoxy structural groups present in the chain extender molecular. BADGE is an exemplary epoxy chain extender where R is bisphenol A, n is 1, and p is 2.

Other exemplary monomeric epoxy chain extenders include diglycidyl benzenedicarboxylate (Formula D) and triglycidyl benzene tricarboxylate (Formula E).

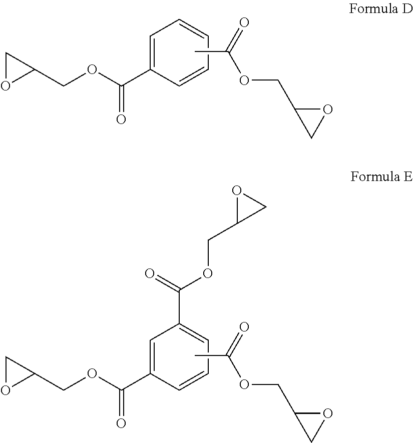

The epoxy-based monomeric chain extender may be present as a component as a percentage of the total weight of the composition. In some aspects, the epoxy-based monomeric chain extender may be present in an amount of from about 1 wt. % to about 10 wt. %, or from 1 wt. % to less than 5 wt. %. For example, the epoxy-based monomeric chain extender may be present in an amount of about 1, 2, 3, 4, 5, 6, 7, 8, 9, or about 10 wt. %. In one aspect, the epoxy-based monomeric chain extender may be present in an amount of about 2.5 wt. %.

As noted herein, the monomeric chain extender is a compound reactive with the alcohol moiety present in the ester oligomer component. Such chain extenders include a dianhydride compound. The dianhydride compound facilitates network formation by undergoing direct esterification with the ester oligomer. In the presence of a suitable catalyst, the dianhydride can undergo ring opening, thereby generating carboxylic acid groups. The generated carboxylic acid groups undergo direct esterification with the alcohol groups of the ester oligomer.

An exemplary class of monomeric chain extender that is reactive with the alcohol moiety present in the ester oligomer include dianhydrides. A preferred dianhydride is a pyromellitic dianhydride as provided in Formula F.

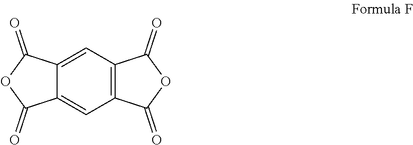 [SMILES: O=c1oc(=O)c2cc3c(=O)oc(=O)c3cc12]

### Catalysts

Certain catalysts may be used to catalyze the reactions described herein. One or more may be used herein to facilitate the formation of a network throughout the compositions disclosed. In one aspect, a catalyst may be used to facilitate the ring opening reaction of epoxy groups of the epoxy chain extender with the carboxylic acid endgroup of the ester oligomer component. This reaction effectively results in chain extension and growth of the ester oligomer component via condensation, as well as to the in-situ formation of additional alcohol groups along the oligomeric backbone of the ester oligomer component. Furthermore, such a catalyst may subsequently facilitate the reaction of the generated alcohol groups with the ester groups of the ester oligomer component (a process called transesterification), leading to network formation. When such a catalyst remains active, and when free alcohol groups are available in the resulting network, the continuous process of transesterification reactions leads to a dynamic polymer network.

As described herein, certain catalysts may be referenced as being a transesterification catalyst or a polycondensation catalyst. Although certain catalysts may be sufficient for use as both a transesterification and a polycondensation catalyst, for simplification, the following description details certain aspects of the transesterification catalyst and the polycondensation catalyst separately. It is understood that such separation and description is intended for example only and is not intended to be limiting regarding the user of various catalysts in various aspects of the processes described herein.

### Transesterification Catalyst

An example catalyst, as described herein, may be referred to as a transesterification catalyst. Generally, a transesterification catalyst facilitates the exchange of an alkoxy group of an ester by another alcohol. The transesterification catalyst as used herein facilitates reaction of free alcohol groups with ester groups in the backbone of the ester oligomer or its final dynamic polymer network. As mentioned before, these free alcohol groups are generated in-situ in a previous step by the ring-opening reaction of the epoxy chain extender with the carboxylic acid endgroups of the ester oligomer component. Certain transesterification catalysts are known in the art and are usually chosen from metal salts, for example, acetylacetonates, of zinc, tin, magnesium, cobalt, calcium, titanium, and zirconium. In certain aspects, the transesterification catalyst(s) is used in an amount up to about 25 wt. %, for example, about 0.001 wt. % to about 25 wt. %, of the total molar amount of ester groups in the ester oligomer component. In some aspects, the transesterification catalyst is used in an amount of from about 0.001 wt. % to about 10 wt. % or from about 0.001 wt. % to less than about 5 wt. %. Preferred aspects include about 0.001, about 0.05, about 0.1, and about 0.2 wt. % of catalyst, based on the number of ester groups in the ester oligomer component.

Suitable transesterification catalysts are also described in Otera, J. Chem. Rev. 1993, 93, 1449-1470. Tests for determining whether a catalyst will be appropriate for a given polymer system within the scope of the disclosure are described in, for example, U.S. Published Application No. 2011/0319524 and WO 2014/086974.

Tin compounds such as dibutyltinlaurate, tin octanote, dibutyltin oxide, dioxtyltin, dibutyldimethoxytin, tetraphenyltin, tetrabutyl-2,3-dichlorodistannoxane, and all other stannoxanes are envisioned as suitable catalysts. Rare earth salts of alkali metals and alkaline earth metals, particularly rare earth acetates, alkali metal and alkaline earth metals such as calcium acetate, zinc acetate, tin acetate, cobalt acetate, nickel acetate, lead acetate, lithium acetate, manganese acetate, sodium acetate, and cerium acetate are other catalysts that can be used. Salts of saturated or unsaturated fatty acids and metals, alkali metals, alkaline earth and rare earth metals, for example zinc stearate, are also envisioned as suitable catalysts. The catalyst may also be an organic compound, such as benzyldimethylamide or benzyltrimethylammonium chloride. These catalysts are generally in solid form, and advantageously in the form of a finely divided powder. A preferred catalyst is zinc(II)acetylacetonate.

### Polycondensation Catalyst

In some aspects, the compositions of the present disclosure are prepared using a polycondensation catalyst. The polycondensation catalyst may increase the polymer chain length (and molecular weight) by facilitating the condensation reaction between alcohol and carboxylic acid endgroups of the ester oligomer component in an esterification reaction. Alternatively, this catalyst may facilitate the ring opening reaction of the epoxy groups in the epoxy chain extender with the carboxylic acid endgroups of the ester oligomer component. The polycondensation catalyst is used in an amount of between 10 ppm and 100 ppm with respect to the ester groups in the ester oligomer component. In some aspects, the polycondensation catalyst is used in an amount of from 10 ppm to 100 ppm or from 10 ppm to less than 75 ppm. Preferred aspects include 20 ppm, 30 ppm, 50 ppm of catalyst, based on the oligomer component of the present disclosure. In a preferred aspect, the polycondensation catalyst is used in an amount of 50 ppm or about 0.005 wt. %.

Various titanium (Ti) based compounds have been proposed as polycondensation catalysts, because they are relatively inexpensive and safe. Described titanium-based catalysts include tetra-n-propyl titanate, tetraisopropyl titanate, tetra-n-butyl titanate, tetraphenyl titanate, tetracyclohexyl titanate, tetrabenzyl titanate, tetra-n-butyl titanate tetramer, titanium acetate, titanium glycolates, titanium oxalates, sodium or potassium titanates, titanium halides, titanate hexafluorides of potassium, manganese and ammonium, titanium acetylacetate, titanium alkoxides, titanate phosphites etc. The use of titanium based polycondensation catalysts in the production of polyesters has been described in EP0699700, U.S. Pat. No. 3,962,189, JP52062398, U.S. Pat. Nos. 6,372,879, and 6143837, for example. An exemplary titanium based polycondensation catalyst of the present disclosure is titanium(IV) isopropoxide, also known as tetraisopropyl titanate.

Other transesterification or polycondensation catalysts that can be used include metal oxides such as zinc oxide, antimony oxide, and indium oxide; metal alkoxides such as titanium tetrabutoxide, titanium propoxide, titanium isopropoxide, titanium ethoxide, zirconium alkoxides, niobium alkoxides, tantalum alkoxides; alkali metals; alkaline earth metals, rare earth alcoholates and metal hydroxides, for example sodium alcoholate, sodium methoxide, potassium alkoxide, and lithium alkoxide; sulfonic acids such as sulfuric acid, methane sulfonic acid, paratoluene sulfonic acid; phosphines such as triphenylphosphine, dimethylphenylphosphine, methyldiphenylphosphine, triterbutylphosphine; and phosphazenes.

### Additives

One or more additives may be combined with the components of the dynamic or pre-dynamic cross-linked polymer to impart certain properties to the polymer composition. Exemplary additives include: one or more polymers, ultraviolet agents, ultraviolet (UV) stabilizers, heat stabilizers, antistatic agents, anti-microbial agents, anti-drip agents, radiation stabilizers, pigments, dyes, fibers, fillers, plasticizers, fibers, flame retardants, antioxidants, lubricants, impact modifiers, wood, glass, and metals, and combinations thereof.

The compositions described herein may comprise a UV stabilizer for dispersing UV radiation energy. The UV stabilizer does not substantially hinder or prevent cross-linking of the various components of the compositions described herein. UV stabilizers may be hydroxybenzophenones; hydroxyphenyl benzotriazoles; cyanoacrylates; oxanilides; or hydroxyphenyl triazines. The compositions described herein may comprise heat stabilizers. Exemplary heat stabilizer additives include, for example, organophosphites such as triphenyl phosphite, tris-(2,6-dimethylphenyl)phosphite, tris-(mixed mono-and di-nonylphenyl)phosphite or the like; phosphonates such as dimethylbenzene phosphonate or the like; phosphates such as trimethyl phosphate, or the like; or combinations thereof.

The compositions described herein may comprise an antistatic agent. Examples of monomeric antistatic agents may include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations comprising at least one of the foregoing monomeric antistatic agents.

Exemplary polymeric antistatic agents may include certain polyesteramides polyether-polyamide (polyetheramide) block copolymers, polyetheresteramide block copolymers, polyetheresters, or polyurethanes, each containing polyalkylene glycol moieties polyalkylene oxide units such as polyethylene glycol, polypropylene glycol, polytetramethylene glycol, and the like. Such polymeric antistatic agents are commercially available, for example PELESTAT™ 6321 (Sanyo) or PEBAX™ MH1657 (Atofina), IRGASTAT™ P18 and P22 (Ciba-Geigy). Other polymeric materials may be used as antistatic agents are inherently conducting polymers such as polyaniline (commercially available as PANIPOL™EB from Panipol), polypyrrole and polythiophene (commercially available from Bayer), which retain some of their intrinsic conductivity after melt processing at elevated temperatures. Carbon fibers, carbon nanofibers, carbon nanotubes, carbon black, or a combination comprising at least one of the foregoing may be included to render the compositions described herein electrostatically dissipative.

The compositions described herein may comprise anti-drip agents. The anti-drip agent may be a fibril forming or non-fibril forming fluoropolymer such as polytetrafluoroethylene (PTFE). The anti-drip agent can be encapsulated by a rigid copolymer as described above, for example styrene-acrylonitrile copolymer (SAN). PTFE encapsulated in SAN is known as TSAN. Encapsulated fluoropolymers can be made by polymerizing the encapsulating polymer in the presence of the fluoropolymer, for example an aqueous dispersion. TSAN can provide significant advantages over PTFE, in that TSAN can be more readily dispersed in the composition. An exemplary TSAN can comprise 50 wt. % PTFE and 50 wt. % SAN, based on the total weight of the encapsulated fluoropolymer. The SAN can comprise, for example, 75 wt. % styrene and 25 wt. % acrylonitrile based on the total weight of the copolymer. Alternatively, the fluoropolymer can be pre-blended in some manner with a second polymer, such as for, example, an aromatic polycarbonate or SAN to form an agglomerated material for use as an anti-drip agent. Either method can be used to produce an encapsulated fluoropolymer.

The compositions described herein may comprise a radiation stabilizer, such as a gamma-radiation stabilizer. Exemplary gamma-radiation stabilizers include alkylene polyols such as ethylene glycol, propylene glycol, 1,3-propanediol, 1,2-butanediol, 1,4-butanediol, meso-2,3-butanediol, 1,2-pentanediol, 2,3-pentanediol, 1,4-pentanediol, 1,4-hexandiol, and the like; cycloalkylene polyols such as 1,2-cyclopentanediol, 1,2-cyclohexanediol, and the like; branched alkylenepolyols such as 2,3-dimethyl-2,3-butanediol (pinacol), and the like, as well as alkoxy-substituted cyclic or acyclic alkanes. Unsaturated alkenols are also useful, examples of which include 4-methyl-4-penten-2-ol, 3-methyl-pentene-3-ol, 2-methyl-4-penten-2-ol, 2,4-dimethyl-4-penten-2-ol, and 9 to decen-1-ol, as well as tertiary alcohols that have at least one hydroxy substituted tertiary carbon, for example 2-methyl-2,4-pentanediol (hexylene glycol), 2-phenyl-2-butanol, 3-hydroxy-3-methyl-2-butanone, 2-phenyl-2-butanol, and the like, and cyclic tertiary alcohols such as 1-hydroxy-1-methyl-cyclohexane. Certain hydroxymethyl aromatic compounds that have hydroxy substitution on a saturated carbon attached to an unsaturated carbon in an aromatic ring can also be used. The hydroxy-substituted saturated carbon can be a methylol group (—CH₂OH) or it can be a member of a more complex hydrocarbon group such as —CR²⁴HOH or —CR²⁴₂OH wherein R²⁴ is a complex or a simple hydrocarbon. Specific hydroxy methyl aromatic compounds include benzhydrol, 1,3-benzenedimethanol, benzyl alcohol, 4-benzyloxy benzyl alcohol and benzyl alcohol. 2-Methyl-2,4-pentanediol, polyethylene glycol, and polypropylene glycol are often used for gamma-radiation stabilization.

The term “pigments” means colored particles that are insoluble in the resulting compositions described herein. Exemplary pigments include titanium oxide, carbon black, carbon nanotubes, metal particles, silica, metal oxides, metal sulfides or any other mineral pigment; phthalocyanines, anthraquinones, quinacridones, dioxazines, azo pigments or any other organic pigment, natural pigments (madder, indigo, crimson, cochineal, etc.) and mixtures of pigments. The pigments may represent from 0.05% to 15% by weight relative to the weight of the overall composition. Pigments, dyes or fibers capable of absorbing radiation may be used to ensure the heating of an article based on the compositions described herein when heated using a radiation source such as a laser, or by the Joule effect, by induction or by microwaves. Such heating may allow the use of a process for manufacturing, transforming or recycling an article made of the compositions described herein. The term “dye” refers to molecules that are soluble in the compositions described herein and that have the capacity of absorbing part of the visible radiation.

Exemplary fibers include glass fibers, carbon fibers, polyester fibers, polyamide fibers, aramid fibers, cellulose and nanocellulose fibers or plant fibers (linseed, hemp, sisal, bamboo, etc.) may also be envisaged.

Suitable fillers for the compositions described herein include: silica, clays, calcium carbonate, carbon black, kaolin, and whiskers. Other possible fillers include, for example, silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin comprising various coatings known in the art to facilitate compatibility with the polymeric matrix, or the like; single crystal fibers or “whiskers” such as silicon carbide, alumina, boron carbide, iron, nickel, copper, or the like; fibers (including continuous and chopped fibers) such as asbestos, carbon fibers, glass fibers, such as E, A, C, ECR, R, S, D, or NE glasses, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents.

Plasticizers, lubricants, and mold release agents can be included. Mold release agent (MRA) will allow the material to be removed quickly and effectively. Mold releases can reduce cycle times, defects, and browning of finished product. There is considerable overlap among these types of materials, which may include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate (PETS), and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, e.g., methyl stearate and polyethylene-polypropylene glycol copolymer in a suitable solvent; waxes such as beeswax, montan wax, paraffin wax, or the like.

Various types of flame retardants can be utilized as additives. In one aspect, the flame retardant additives include, for example, flame retardant salts such as alkali metal salts of perfluorinated C₁-C₁₆ alkyl sulfonates such as potassium perfluorobutane sulfonate (Rimar salt), potassium perfluoroctane sulfonate, tetraethylammonium perfluorohexane sulfonate, potassium diphenylsulfone sulfonate (KSS), and the like, sodium benzene sulfonate, sodium toluene sulfonate (NATS) and the like; and salts formed by reacting for example an alkali metal or alkaline earth metal (for example lithium, sodium, potassium, magnesium, calcium and barium salts) and an inorganic acid complex salt, for example, an oxo-anion, such as alkali metal and alkaline-earth metal salts of carbonic acid, such as Na₂CO₃, K₂CO₃, MgCO₃, CaCO₃, and BaCO₃ or fluoro-anion complex such as Li₃AlF₆, BaSiF₆, KBF₄, K₃AlF₆, KAlF₄, K₂SiF₆, and/or Na₃AlF₆ or the like. Rimar salt and KSS and NATS, alone or in combination with other flame retardants, are particularly useful in the compositions disclosed herein. In certain aspects, the flame retardant does not contain bromine or chlorine.

The flame retardant additives may include organic compounds that include phosphorus, bromine, and/or chlorine. In certain aspects, the flame retardant is not a bromine or chlorine containing composition. Non-brominated and non-chlorinated phosphorus-containing flame retardants can include, for example, organic phosphates and organic compounds containing phosphorus-nitrogen bonds. Exemplary di- or polyfunctional aromatic phosphorus-containing compounds include resorcinol tetraphenyl diphosphate (RDP), the bis(diphenyl) phosphate of hydroquinone and the bis(diphenyl) phosphate of bisphenol-A, respectively, their oligomeric and polymeric counterparts, and the like. Other exemplary phosphorus-containing flame retardant additives include phosphonitrilic chloride, phosphorus ester amides, phosphoric acid amides, phosphonic acid amides, phosphinic acid amides, tris(aziridinyl) phosphine oxide, polyorganophosphazenes, and polyorganophosphonates.

The flame retardant optionally is a non-halogen based metal salt, e.g., of a monomeric or polymeric aromatic sulfonate or mixture thereof. The metal salt is, for example, an alkali metal or alkali earth metal salt or mixed metal salt. The metals of these groups include sodium, lithium, potassium, rubidium, cesium, beryllium, magnesium, calcium, strontium, francium and barium. Examples of flame retardants include cesium benzenesulfonate and cesium p-toluenesulfonate. See e.g., U.S. Pat. No. 3,933,734, EP 2103654, and US2010/0069543A1, the disclosures of which are incorporated herein by reference in their entirety.

Another useful class of flame retardant is the class of cyclic siloxanes having the general formula [(R)2SiO]y wherein R is a monovalent hydrocarbon or fluorinated hydrocarbon having from 1 to 18 carbon atoms and y is a number from 3 to 12. Examples of fluorinated hydrocarbon include, but are not limited to, 3-fluoropropyl, 3,3,3-trifluoropropyl, 5,5,5,4,4,3,3-heptafluoropentyl, fluorophenyl, difluorophenyl and trifluorotolyl. Examples of suitable cyclic siloxanes include, but are not limited to, octamethylcyclotetrasiloxane, 1,2,3,4-tetramethyl-1,2,3,4-tetravinylcyclotetrasiloxane, 1,2,3,4-tetramethyl-1,2,3,4-tetraphenylcyclotetrasiloxane, octaethylcyclotetrasiloxane, octapropylcyclotetrasiloxane, octabutylcyclotetrasiloxane, decamethylcyclopentasiloxane, dodecamethylcyclohexasiloxane, tetradecamethylcycloheptasiloxane, hexadecamethylcyclooctasiloxane, eicosamethylcyclodecasiloxane, octaphenylcyclotetrasiloxane, and the like. A particularly useful cyclic siloxane is octaphenylcyclotetrasiloxane.

Exemplary antioxidant additives include organophosphites such as tris(nonyl phenyl)phosphite, tris(2,4-di-t-butylphenyl)phosphite (“IRGAFOS™ 168” or “I-168”), bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants.

### Articles and Processes

Articles can be formed from the compositions described herein. Generally, the ester oligomer component, the monomeric chain extender, and the transesterification and polycondensation catalysts are combined and heated to provide a molten mixture which is reacted under decreased pressure to form the dynamic cross-linked compositions described herein. The compositions described herein can then form, shaped, molded, or extruded into a desired shape. The term “article” refers to the compositions described herein being formed into a particular shape. As an example, articles may be formed from the dynamic cross-linked polymer compositions of the present disclosure and may include composites, a thermoformed material, or a combination thereof. The articles may further comprise a solder bonded to the formed article. It is understood that such examples are not intended to be limiting, but are illustrative in nature. It is understood that the subject compositions may be used for various articles and end-use applications.

With thermosetting resins of the prior art, once the resin has hardened (i.e. reached or exceeded the gel point), the article can no longer be transformed or repaired or recycled. Applying a moderate temperature to such an article does not lead to any observable or measurable transformation, and the application of a very high temperature leads to degradation of this article. In contrast, articles formed from the dynamic cross-linked polymer compositions described herein, on account of their particular composition, can be transformed, repaired, or recycled by raising the temperature of the article.

From a practical point of view, this means that over a broad temperature range, the article can be deformed, with internal constraints being removed at higher temperatures. Without being bound by theory, it is believed that transesterification exchanges in the dynamic cross-linked polymer compositions are the cause of the relaxation of constraints and of the variation in viscosity at high temperatures. In terms of application, these materials can be treated at high temperatures, where a low viscosity allows injection or molding in a press. It should be noted that, contrary to Diels-Alder reactions, no depolymerisation is observed at high temperatures and the material conserves its cross-linked structure. This property allows the repair of two parts of an article. No mold is necessary to maintain the shape of the components during the repair process at high temperatures. Similarly, components can be transformed by application of a mechanical force to only one part of an article without the need for a mold, since the material does not flow.

Raising the temperature of the article can be performed by any known means such as heating by conduction, convection, induction, spot heating, infrared, microwave or radiant heating. Devices for increasing the temperature of the article in order to perform the processes of described herein can include: an oven, a microwave oven, a heating resistance, a flame, an exothermic chemical reaction, a laser beam, a hot iron, a hot-air gun, an ultrasonication tank, a heating punch, etc. The temperature increase can be performed in discrete stages, with their duration adapted to the expected result.

Although the dynamic cross-linked polymer compositions do not flow during the transformation, by means of the transesterification reactions, by selecting an appropriate temperature, heating time and cooling conditions, the new shape may be free of any residual internal constraints. The newly shaped dynamic cross-linked polymer compositions are thus not embrittled or fractured by the application of the mechanical force. Furthermore, the article will not return to its original shape. Specifically, the transesterification reactions that take place at high temperature promote a reorganization of the cross-linking points of the polymer network so as to remove any stresses caused by application of the mechanical force. A sufficient heating time makes it possible to completely cancel these stresses internal to the material that have been caused by the application of the external mechanical force. This makes it possible to obtain stable complex shapes, which are difficult or even impossible to obtain by molding, by starting with simpler elemental shapes and applying mechanical force to obtain the desired more complex final shape. Notably, it is very difficult to obtain by molding shapes resulting from twisting. An article made from a dynamic cross-linked polymer composition can be heated and deformed, and upon returning to the original temperature, maintains the deformed shape. As such, articles in accordance with the present disclosure may comprises a shape generated by applying mechanical forces to a molded piece formed from the dynamic cross-linked polymer composition.

According to one variant, a process for obtaining and/or repairing an article based on a dynamic cross-linked polymer composition described herein comprises: placing in contact with each other two articles formed from a dynamic cross-linked polymer composition; and heating the two articles so as to obtain a single article. The heating temperature (T) is generally within the range from 50° C. to 250° C., including from 100° C. to 200° C.

An article made of dynamic cross-linked polymer compositions as described herein may also be recycled by direct treatment of the article, for example, the broken or damaged article is repaired by means of a transformation process as described above and may thus regain its prior working function or another function. Alternatively, the article is reduced to particles by application of mechanical grinding, and the particles thus obtained may then be used to manufacture a new article.

### Aspects

The present disclosure comprises at least the following aspects.

Aspect 1. A method of preparing a pre-dynamic or dynamic cross-linked polymer composition comprising: combining: an ester oligomer component; a monomeric chain extender; a transesterification catalyst; and a polycondensation catalyst; at a temperature and for a time sufficient to form a molten mixture; and heating the molten mixture at a polycondensation temperature and at a polycondensation pressure for a time sufficient to initiate polycondensation and to form the pre-dynamic or dynamic cross-linked polymer composition.

Aspect 2. A method of preparing a pre-dynamic or a dynamic cross-linked polymer composition consisting essentially of: combining: an ester oligomer component; a monomeric chain extender; a transesterification catalyst; and a polycondensation catalyst; at a temperature and for a time sufficient to form a molten mixture; and heating the molten mixture at a polycondensation temperature and at a polycondensation pressure for a time sufficient to initiate polycondensation and to form the pre-dynamic or dynamic cross-linked polymer composition.

Aspect 3. A method of preparing a pre-dynamic or a dynamic cross-linked polymer composition consisting of: combining: an ester oligomer component; a monomeric chain extender; a transesterification catalyst; and a polycondensation catalyst; at a temperature and for a time sufficient to form a molten mixture; and heating the molten mixture at a polycondensation temperature and at a polycondensation pressure for a time sufficient to initiate polycondensation and to form the pre-dynamic or dynamic cross-linked polymer composition.

Aspect 4. A method of preparing a dynamic cross-linked polymer composition comprising: combining: an ester oligomer component; a monomeric chain extender; a transesterification catalyst; and a polycondensation catalyst; at a temperature and for a time sufficient to form a molten mixture; and heating the molten mixture at a polycondensation temperature and at a polycondensation pressure for a time sufficient to initiate polycondensation and to form the dynamic cross-linked polymer composition.

Aspect 5. A method of preparing a dynamic cross-linked polymer composition consisting essentially of: combining: an ester oligomer component; a monomeric chain extender; a transesterification catalyst; and a polycondensation catalyst; at a temperature and for a time sufficient to form a molten mixture; and heating the molten mixture at a polycondensation temperature and at a polycondensation pressure for a time sufficient to initiate polycondensation and to form the dynamic cross-linked polymer composition.

Aspect 6. A method of preparing a dynamic cross-linked polymer composition consisting of: combining: an ester oligomer component; a monomeric chain extender; a transesterification catalyst; and a polycondensation catalyst; at a temperature and for a time sufficient to form a molten mixture; and heating the molten mixture at a polycondensation temperature and at a polycondensation pressure for a time sufficient to initiate polycondensation and to form the dynamic cross-linked polymer composition.

Aspect 7. The method of aspect 1, wherein the ester oligomer component has an intrinsic viscosity of between 0.09 dl/g and 0.35 dl/g.

Aspect 8. The method of any one of the preceding aspects, wherein the ester oligomer component has a carboxylic acid endgroup concentration between 20 mmol/kg and 120 mmol/kg.

Aspect 9. The method of any one of the preceding aspects, wherein the temperature sufficient to form the molten mixture is a temperature just below or at the melting temperature of the ester oligomer component.

Aspect 10. The method of any one of the preceding aspects, wherein the temperature sufficient to form the molten mixture is between 230° C. and 260° C.

Aspect 11. The method of any one of the preceding aspects, wherein the polycondensation temperature is between about 240° C. and 265° C., preferably about 260° C.

Aspect 12. The method of any one of the preceding aspects, wherein the polycondensation pressure is a value less than atmospheric pressure at which the molten mixture was formed.

Aspect 13. The method of any one of the preceding aspects, wherein the polycondensation pressure is maintained at less than or equal to about 1 mmHg.

Aspect 14. The method of any one of the preceding aspects, wherein the ester oligomer component is an alkylene terephthalate oligomer, preferably a butylene terephthalate oligomer.

Aspect 15. The method of any one of the preceding aspects, wherein the ester oligomer component is butylene terephthalate oligomer derived from terephthalic acid.

Aspect 16. The method of any one of the preceding aspects, wherein the transesterification catalyst is zinc(II)acetate.

Aspect 17. The method of any one of the preceding aspects, wherein the transesterification catalyst is present at 0.001 wt. % to 25 wt. %, based on the number of ester groups in the ester component.

Aspect 18. The method of any of the preceding aspects, wherein the polycondensation catalyst is titanium(IV) isopropoxide.

Aspect 19. The method of any of the preceding aspects, wherein the monomeric chain extender is reactive with the carboxylic acid endgroup or with the alcohol endgroup functionality of the ester oligomer component.

Aspect 20. The method of any of the preceding aspects, wherein the monomeric chain extender comprises a bisphenol A epoxy, a 3,4-epoxy cyclohexyl methyl-3,4-epoxy cyclohexyl carboxylate, or a pyromellitic dianhydride, or a combination thereof.

Aspect 21. The method of any of the preceding aspects, wherein the transesterification catalyst and the polycondensation catalyst comprise at least a portion of the same catalyst.

Aspect 22. A method of forming an article comprising a dynamic cross-linked polymer composition comprising: preparing a dynamic cross-linked polymer composition according to any one of aspects 1 to 16; and subjecting the dynamic cross-linked polymer to a polymer forming process, such as compression molding, profile extrusion, injection molding, or blow molding to form the article.

Aspect 23. An article formed from the dynamic cross-linked polymer composition prepared using any one of aspects 1-22, wherein the article comprises one or more of a composite, a thermoformed material, or a combination thereof.

Aspect 24. The article of aspect 23, wherein the article comprises a shape generated by applying mechanical forces to a molded piece formed from the dynamic cross-linked polymer composition.

Aspect 25. A method of preparing a dynamic cross-linked polymer composition comprising: combining: an ester oligomer component; a monomeric chain extender; a transesterification catalyst; and a polycondensation catalyst; at a temperature and for a time sufficient to form a molten mixture; and heating the molten mixture at a polycondensation temperature and at a polycondensation pressure for a time sufficient to initiate polycondensation and to form the dynamic cross-linked polymer composition, wherein a polycondensation catalyst quencher is not combined with the ester oligomer component, monomeric chain extender, transesterification catalyst, and or polycondensation catalyst.

Aspect 26. The method of aspect 25, wherein the dynamic cross-linked polymer composition (a) has a plateau modulus of from about 0.01 MPa to about 1000 MPa when measured by dynamic mechanical analysis at a temperature above the melting temperature of the polyester component of the pre-dynamic cross-linked composition and (b) exhibits the capability of relaxing internal residual stresses at a characteristic timescale of between 0.1 and 100,000 seconds above the glass transition temperature of the base polymer, as measured by stress relaxation rheology measurement.

Aspect 27. The method of any one of aspects 25-26, wherein the ester oligomer component comprises a poly(alkylene terephthalate).

Aspect 28. The method of any one of aspects 25-27, wherein the ester oligomer component comprises a C2 to C20 alkylene.

Aspect 29. The method of any one of aspects 25-28, wherein the ester oligomer component comprises a poly(butylene terephthalate), a poly(ethylene terephthalate), a poly(propylene terephthalate), or any combination thereof.

Aspect 30. The method of any one of aspects 25-29, wherein the ester oligomer component comprises a poly(butylene terephthalate).

Aspect 31. The method of any one of aspects 25-30, wherein the transesterification catalyst is zinc(II)acetylacetonate.

Aspect 32. The method of any one of aspects 25-31, wherein the polycondensation catalyst is titanium(IV)(iso)butoxide.

Aspect 33. The method of any one of aspects 25-32, wherein the polycondensation catalyst comprises tetra-n-propyl titanate, tetraisopropyl titanate, tetra-n-butyl titanate, tetraphenyl titanate, tetracyclohexyl titanate, tetrabenzyl titanate, tetra-n-butyl titanate tetramer, titanium acetate, titanium glycolates, titanium oxalates, sodium or potassium titanates, titanium halides, titanate hexafluorides of potassium, manganese and ammonium, titanium acetylacetate, titanium alkoxides, titanate phosphites, or a combination thereof.

The following examples are provided to illustrate the compositions, processes, and properties of the present disclosure. The examples are merely illustrative and are not intended to limit the disclosure to the materials, conditions, or process parameters set forth therein.

### EXAMPLES

### Materials

PBT-315
BT-oligomers (oligomer containing butylene terephthalate) (intrinsic viscosity 0.11 dl/g and 0.13 dl/g corresponding to number average molecular weight between 800 and 2000 Daltons) (Nation Ford Chemicals)
Cycloaliphatic epoxy chain extender (ERL Epoxy) (253 grams per mole, g/mol; epoxy equivalent at 135 grams per equivalent) (ERL-4221) DOW Chemical Co. USA)
Bisphenol-A epoxy chain extender (BPA epoxy) (1000 Daltons Mw; epoxy equivalent at 530 g/equivalent) (Brenntag Specialties INC)
Pyromellitic Dianhydride (PMDA) (Acros Chemicals)
Zinc(II)acetate (H₂O) (Acros Chemicals)
Titanium(IV) isopropoxide (tetraisopropyl titanate, TPT) (Commercial Tyzor grade, Dorf Ketal)
Purified Terephthalic Acid (PTA, purity greater than 99%) (CEPSA Chemicals)
Butanediol (BDO) (BASF)

### Formation of Purified Terephthalic Acid (PTA) Based Butylene Terephthalate Oligomers

Butanediol (BDO) was transferred under vacuum from a storage reactor at 100° C. to a reactor vessel equipped with an overhead column and condenser column. A hot oil unit was used to control the temperature of the reactor vessel and thermocouples were used to observe the reactor vessel and hot oil unit. The temperature of the hot oil unit was maintained between 265° C. and 300° C. and the contents of the reactor vessel were continuously stirred. Purified terephthalic Acid (PTA) was added to the reactor vessel and the temperature was increased. Upon melting of the reactor vessel contents at 170° C., titanium(IV) isopropoxide (TPT) mixed with a portion of BDO was introduced to the reactor vessel. The contents of the reactor vessel were allowed to reach the desired temperature range between 248° C. and 252° C. Samples of the reactor vessel contents were obtained at intervals until the desired internal viscosity (IV) and carboxylic acid endgroup (CEG) concentration was observed. The temperature of the hot oil unit was lowered to bring the temperature of the reactor vessel contents to between 225° C. and 230° C. and stirring or agitation of the contents was stopped. The content of the reactor vessel was then dropped to a belt flaker for solidification. The resultant butylene terephthalate oligomers were also cooled using a water spray and then ground to provide a fine powder.

### Intrinsic Viscosity

The intrinsic viscosity (IV) of the resultant BT-oligomers was measured using an automatic Viscotek Microlab™ 500 series Relative Viscometer Y501. In a typical procedure, 0.5000 g of polymer sample was fully dissolved in a 60/40 mixture (in % by volume) of phenol/1,1,2,2-tetrachloroethane solution (Harrell Industries). Two measurements were taken for each sample, and the result reported was the average of the two measurements.

### Carboxylic Acid Endgroup Concentration

The carboxylic acid endgroup (CEG) of the BT-oligomers was measured using Metrohm-Autotitrator including Titrando 907, 800 Dosino, on 2 ml and 5 ml dosing units and a 814 USB sample processor. In a typical procedure, 1.5-2.0 g of BT-oligomer was fully dissolved in 50 ml of ortho-cresol solvent at 80° C. After dissolving, the sample was cooled to room temperature and 50 ml of ortho-cresol and 1 ml of water were added to the baker. A blank sample for comparative purposes was also prepared. The electrodes and titrant dosing were dipped into the sample solution and the titration was started. The titrant that was used was a 0.01 mol/l solution of KOH in isopropyl alcohol. The electrodes and titrant dosing were dipped into the sample solution and the titration was started. The titrant volume increment was 0.05 ml. Waiting time between dosings was 15 s. The equivalence point was 28 mV. The quantity of KOH dosed in the titrated volume at the equivalence point was calculated and represents the CEG value in mmol/kg sample. The sample titration was repeated twice and the equivalence point was noted for the calculation of CEG value. Carboxylic acid endgroup content was determined according to the following formula:

COOH (milliequivalents per kilogram, meq/kg)=(ml consumed by sample−ml consumed by the blank)* N(normality) of NaOH*1000

### Rheological Properties

Stress relaxation measurements on the samples were performed on an ARES G2 strain controlled rheometer using an 8 mm parallel-plate geometry at a 3% imposed strain (deformation) with a fixed gap of 1 mm. Prior to the stress relaxation measurements, the sample is equilibrated at 250° C. for a minimum of 30 minutes as a post curing step in the rheometer, followed by a small amplitude oscillatory time sweep for 30 minutes at an angular frequency of 10 rad/s to ensure the network formation. All the experiments were performed in a linear viscoelastic regime. Post curing, where necessary, involved heating the sample to about 250° C. for a minimum of 30 minutes.

The formation of a dynamically cross-linked network throughout the composition is also assessed by examining physical properties. Compositions not exhibiting dynamically cross-linked network formation readily dissolve in hexafluoro isopropanol (HFIP). Cross-linked, dynamic cross-linked polymer compositions do not dissolve in HFIP, but rather swell, likely as a result of solvent uptake within the polymer network.

Formation of PBT-DCN from BT-Oligomers

PBT-DCN samples were prepared in the presence of varying amounts of PMDA chain extender according to the respective process step, polycondensation or esterification. See Table 1. A three-neck round bottom flask reactor was charged with 70 g of BT-oligomers as prepared above, 0.2 wt. % zinc(II) acetate catalyst, 50 ppm TPT, and various weight percent amounts of monomeric chain extenders (pyromellitic dianhydride—PMDA). The reactor was heated in an oil bath at 240° C. The contents of the reactor were allowed to melt for 30 minutes while stirring at 260 rpm (revolutions per minute) under a nitrogen atmosphere. After the contents of the reaction vessel were completely melted, the polymerization stage was performed. The oil bath temperature was increased to between 250° C. and 260° C. and the vacuum was decreased to less than 1 mm Hg (millimeter mercury, pressure) for about 67 minutes. The reaction was then stopped and pressure was increased to atmospheric pressure. The resultant PBT-DCN sample was obtained for analysis of the internal viscosity, carboxylic acid endgroup concentration, and rheological properties.

TABLE 1
Batch results of PBT-DCNs at various
loadings of PMDA chain extender

| | Weight Percent PMDA | IV | CEG |
|---|---|---|---|
| Process Step | Load (%) | (dL/g) | (mmol/kg) |
| Polycondensation | 0.35 | 0.61 | 73 |
| Polycondensation | 0.65 | 0.76 | 41 |
| Polycondensation | 0.90 | 0.92 | 55 |
| Polycondensation | 1.20 | 1.11 | 37 |
| Polycondensation | 1.90 | NA | NA |
| Esterification | 0.35 | 0.16 | 195 |
| Esterification | 0.65 | 0.16 | 236 |
| Esterification | 0.9 | 0.16 | 336 |
| Esterification | 1.2 | 0.21 | 348 |

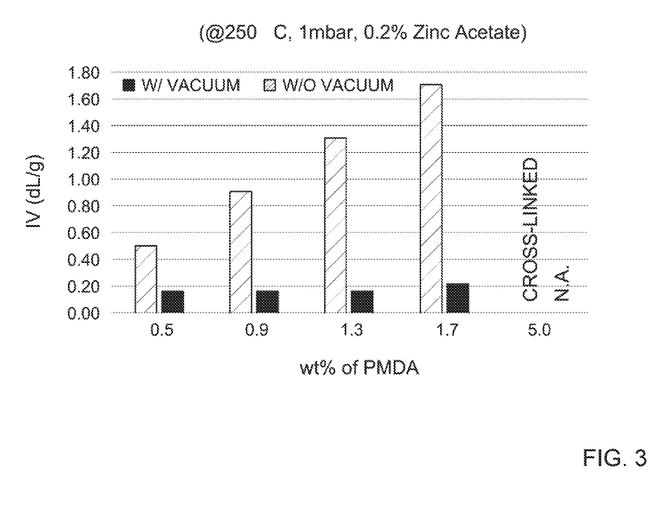

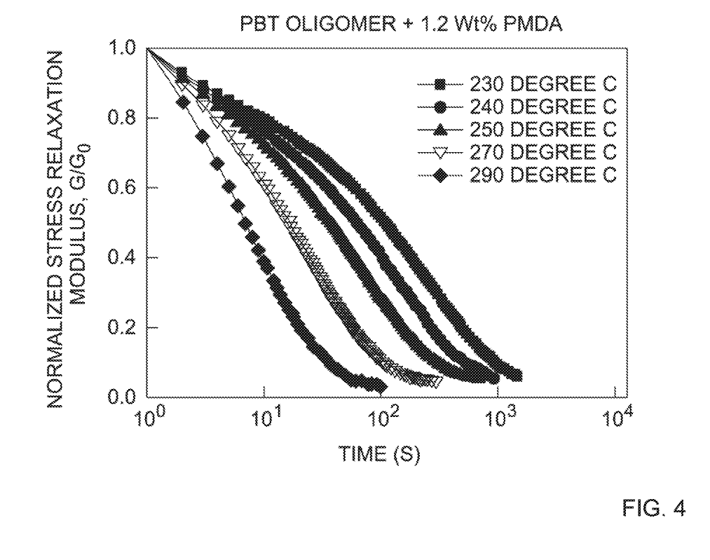

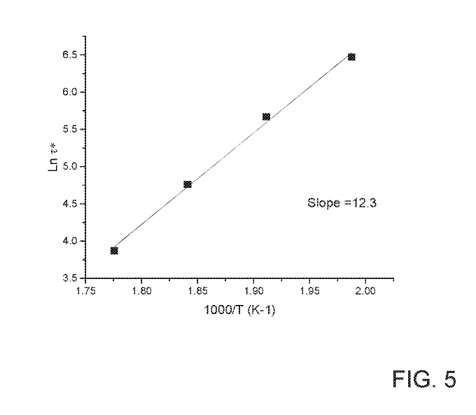

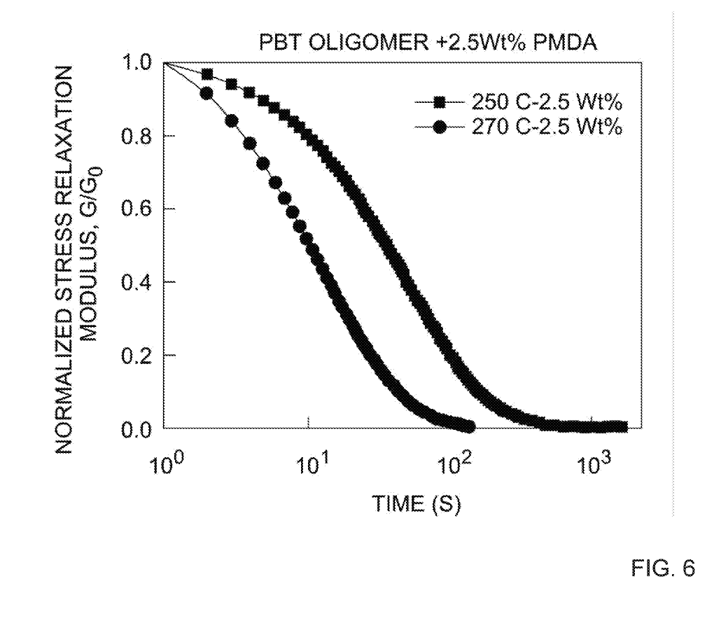

FIG. 3 provides a graphical representation of the effect of PMDA content on the intrinsic viscosity and carboxylic acid endgroup of the samples. According to FIG. 3, “w/vac” indicates the polycondensation process step where the reactor pressure was maintained at 1 mbar (equivalent to less than 1 mm Hg); “w/o vac” refers to the esterification (melting) process step performed at atmospheric pressure. The results of the esterification process step indicated that PMDA is not fully active to carry on the proper chain extension at atmospheric pressure. Table 1 also shows CEG increased to significantly higher values during the esterification process step. This was attributed to a backbiting reaction (the cyclization of the alcohol endgroup of PBT chain producing tetrahydrofuran and CEG) and also attributed to the reaction between PMDA and alcohol endgroups present. Thus during this process step, the reaction between anhydride and alcohol group was significant but chain extension reactions were less apparent. After the reactor pressure was decreased to 1 mbar to initiate the polycondensation process step, the IV increased. See Table 1, FIG. 3. The IV of PBT-DCN gradually increased as the PMDA load increases for each batch. A linear increase was observed in the extent of chain extension and/or branching with the increase of PMDA loading. At 1.9 wt. % of PMDA, a fully cross-linked PBT-DCN was achieved. At this loading, it became impossible to dissolve the sample in any solvent to perform full characterization. Stress relaxation curves of the PBT-DCN compositions at the varying PMDA concentrations and at varying temperatures were also obtained to confirm cross-linking throughout the composition. The normalized stress relaxation modulus was plotted as a function of time. See FIG. 4 and Table 2. The curves of FIG. 4 exhibit the characteristic stress relaxation behavior apparent in dynamic cross-linked compositions as described above. The influence of temperature on stress relaxation modulus demonstrated the ability of the cross-linked network to relieve stress or flow as a function of temperature. The curves at lower temperatures (i.e., 230° C.-250° C.) suggest dynamically cross-linking behavior because of the presence of slower and then more rapid relaxation rates. The possible influence of temperature on the stress relaxation rate in correspondence with transesterification rates is shown in FIG. 5. The characteristic relaxation time τ* exhibited dependence on temperature corresponding to G(t)/G(0)=0.37. FIG. 6 presents the normalized stress relaxation curves of PBT-DCN at 2.5 wt. %. The curves exhibit dynamically cross-linked network behavior characterized by slower and then more rapid relaxation rates at 250° C.

TABLE 2
Stress relaxation rates of PBT-DCN compositions as a function
of time at 230° C. and 270° C.

| | |
|---|---|
| PMDA 1.2 wt. % - 230 C. | PMDA 1.2 wt. % - 270 C. |

| Time[s] | Stress [Pa] | Time [S] | Stress [Pa] |
|---|---|---|---|
| 1 | 3395 | 1 | 1065 |
| 10 | 2690 | 10 | 651 |
| 100 | 1755 | 100 | 120 |
| 500 | 681 | 300 | 45 |
| 1000 | 321 | | |

PBT-DCN samples were prepared in the presence of varying amounts of monomeric BPA epoxy and ERL epoxy chain extender according to the respective process step, polycondensation or esterification. See Table 3. The dynamically cross-linked PBT (PBT-DCN) resins were prepared from BT-oligomers in a laboratory scale batch reactor. A three-neck round bottom flask reactor was charged with 70 g of BT-oligomers as prepared above, 0.2 wt. % zinc(II) acetate catalyst, 50 ppm TPT, and various weight percent amounts of chain extenders (cycloaliphatic epoxy chain extender—ERL epoxy or bisphenol-A epoxy chain extender—BPA epoxy). The reactor was heated in an oil bath at 240° C. The contents of the reactor were allowed to melt for 30 minutes while stirring at 260 rpm (revolutions per minute) under a nitrogen atmosphere. After the contents of the reaction vessel were completely melted, the polymerization stage was performed. The oil bath temperature was increased to between 250° C. and 260° C. and the vacuum was decreased to less than 1 mmHg (millimeter mercury, pressure) for about 67 minutes. The reaction was then stopped and pressure was increased to atmospheric pressure. The resultant PBT-DCN sample was obtained for analysis of the internal viscosity, carboxylic acid endgroup concentration, and rheological properties.

TABLE 3
Batch results of PBT-DCNs at various loadings
of ERL epoxy and BPA epoxy chain extenders

| | Type of Chain | Weight | IV | CEG |
|---|---|---|---|---|
| Process Step | Extender | % | (dl/g) | (mmol/kg) |
| Esterification | ERL-epoxy | 2.5 | 0.16 | 149 |
| Esterification | ERL-epoxy | 5 | 0.17 | 146 |
| Esterification | ERL-epoxy | 10 | 0.16 | 147 |
| Polycondensation | ERL-epoxy | 1.3 | 0.70 | 51 |
| Polycondensation | ERL-epoxy | 2.5 | 0.84 | 50 |
| Esterification | BPA-epoxy | 2.5 | 0.15 | 330 |
| Esterification | BPA-epoxy | 5 | 0.22 | 272 |
| Esterification | BPA-epoxy | 10 | 0.21 | 352 |
| Polycondensation | BPA-epoxy | 1.3 | 1.25 | 53 |
| Polycondensation | BPA-epoxy | 2.5 | Cross-linked | NA |

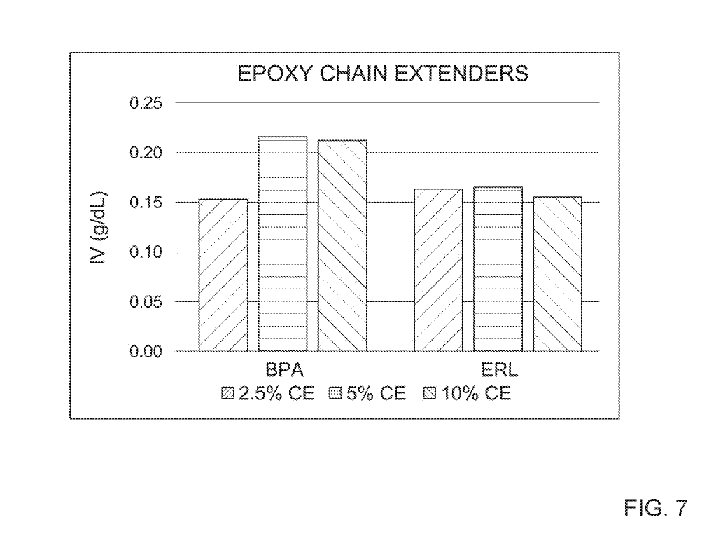

FIG. 7 provides a graphical representation of the effect of monomeric ERL epoxy and BPA epoxy chain extender content (at 2.5 wt. %, 5 wt. %, and 10 wt. %) on the intrinsic viscosity and carboxylic acid endgroup of the samples. Again, the esterification (melt) process step occurred in the absence of a vacuum atmosphere (at atmospheric pressure), while the polycondensation step was performed at decreased pressure (1 mbar, about 0.75 mmHg). The esterification results show that both epoxy cross-linkers and/or chain extenders did not result in high molecular weight of PBT resin. FIG. 7 indicated that BPA epoxy is more reactive with the BT-oligomers compared to the ERL epoxy evidenced by the overall higher IV observed with the BPA epoxy chain extenders. This trend was attributed to the aromatic primary alcohol (related to BPA epoxy) being more reactive compared to the aliphatic primary alcohol (related to ERL epoxy).

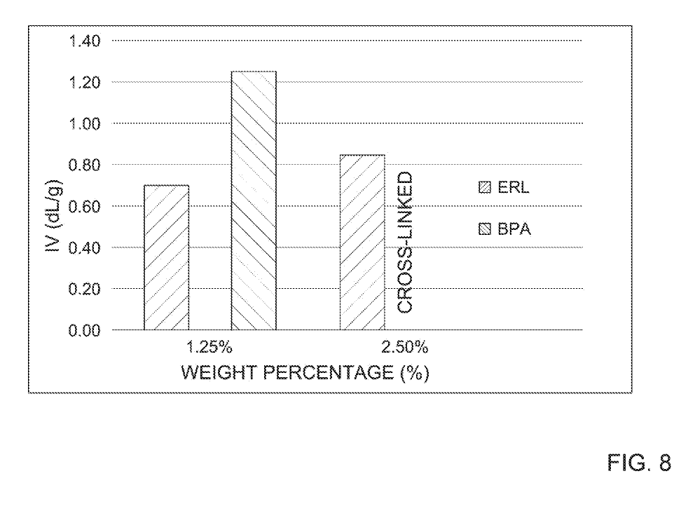

The effect of lower loadings of the chain extenders was also observed. See Table 3, and emphasized in FIG. 8. High molecular weight PBT-DCNs were achieved in the presence of epoxy type chain extenders. BPA epoxy chain extender and/or cross-linker was more reactive and provided a fully cross-linked resin at 2.5 wt. % loading. The batch polycondensation results of PBT-DCNs prepared in the presence of BPA epoxy and ERL epoxy chain extenders at 1.25 and 2.5 weight% load are presented in FIG. 8. As the reactor pressure was decreased for the polycondensation process step, the IV of PBT-DCNs increased to greater than 0.7 dL/g which is corresponds to a high molecular weight resin. Again, the ERL epoxy was less reactive compared to the BPA epoxy as shown in the overall higher IV for the samples with BPA epoxy chain extender. This was attributed to the different reaction mechanisms of ERL epoxy and BPA epoxy during the chain extension process. Therefore, the polycondensation process in the presence of BPA epoxy (1.25 wt. % load) chain extender resulted in an intrinsic viscosity of 1.25 dL/g (corresponding to the highest commercial PBT molecular weight) in a short residence time. After increasing the BPA epoxy chain extender and/or cross-linker load from 1.25 wt. % to 2.5 wt. %, a cross-linked PBT-DCN resin composition was readily obtained. Because the resin composition cross-linked, the resin did not dissolve in any solvent to allow for IV and CEG characterizations.

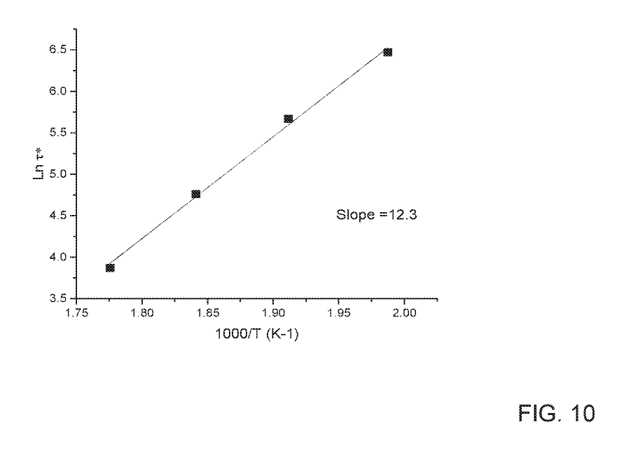

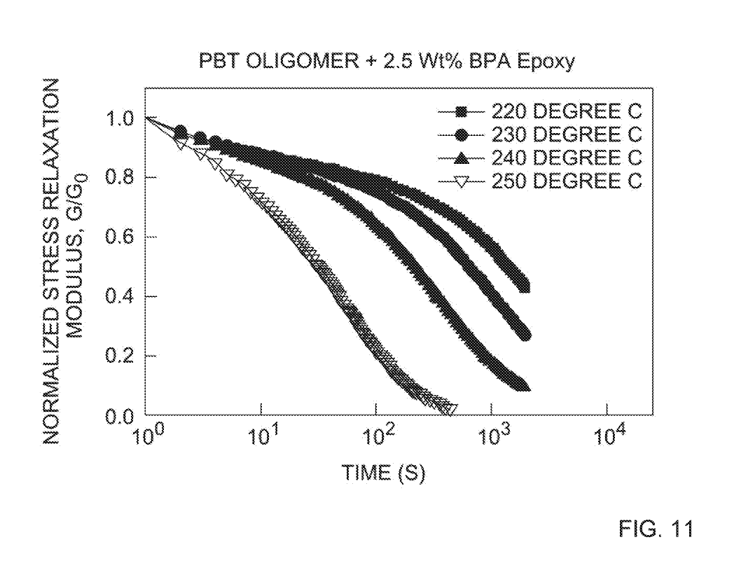

Stress relaxation curves were also observed for the dynamically cross-linked PBT synthesized via BT-oligomers with 2.5 wt. % BPA epoxy chain extender and with 2.5 wt. % ERL epoxy chain extender in the presence of zinc(II) acetate. FIG. 9 provides the stress relaxation curves for PBT-DCN synthesized via BT-oligomers with 2.5 wt. % BPA epoxy chain extender. The characteristic relaxation time τ* exhibited dependence on temperature corresponding to G(t)/G(0)=0.37 as shown in FIG. 10. FIG. 11 also shows the normalized stress relaxation modulus as a function of time for the dynamically cross-linked networks synthesized via BT-oligomers with 2.5 wt. % of BPA epoxy cross-linking agent and/or chain extender.

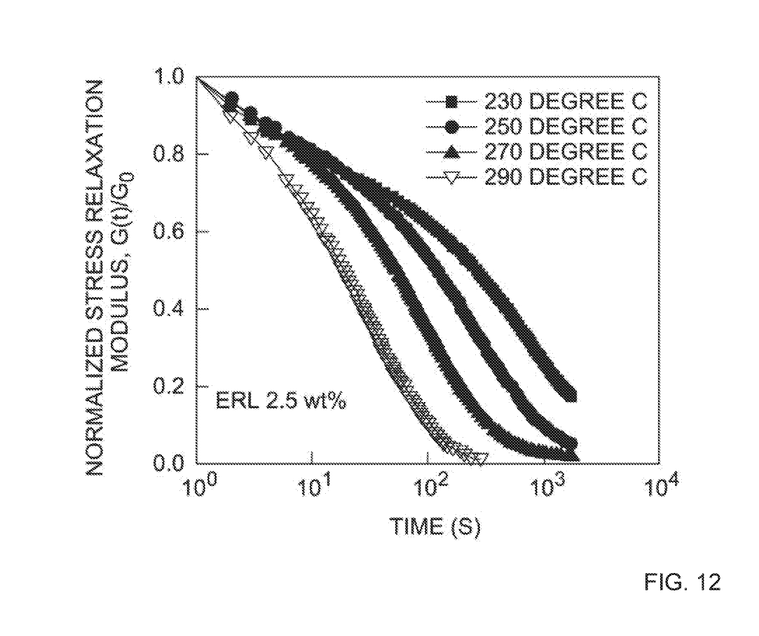

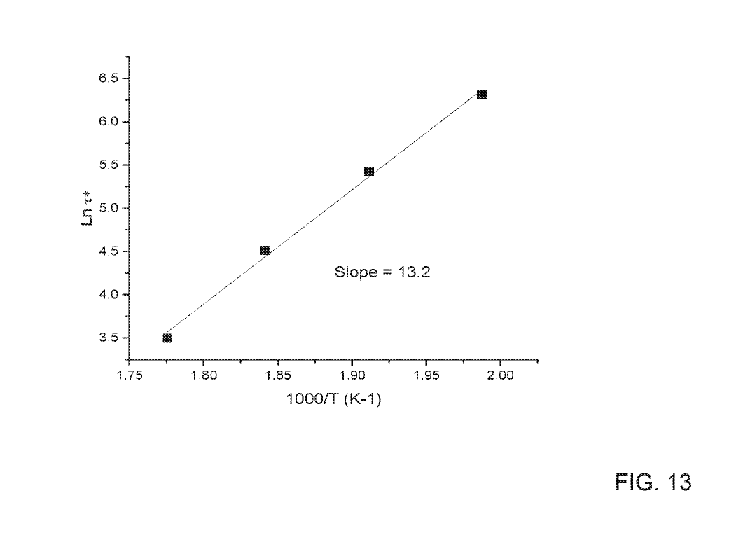

FIG. 12 shows the stress relaxation curves for PBT-DCN synthesized via BT-oligomers with 2.5 wt. % ERL epoxy chain extender. FIG. 12 demonstrates the relaxation time τ* exhibited dependence on temperature corresponding to G(t)/G(0)=0.37 as shown. Similar to the PBT-DCN resin observed with PMDA, the PBT-DCN resin having BPA epoxy chain extender exhibited characteristic dynamic cross-linked network properties. However, the stress relaxation modulus plotted as a function of time for the ERL epoxy based chain extender established a less robust cross-linked network. FIG. 13 provides the Arrhenius plot showing the temperature dependence of the characteristic relaxation time τ* for sample prepared with 2.5 wt. % ERL epoxy chain extender or cross-linking agent.

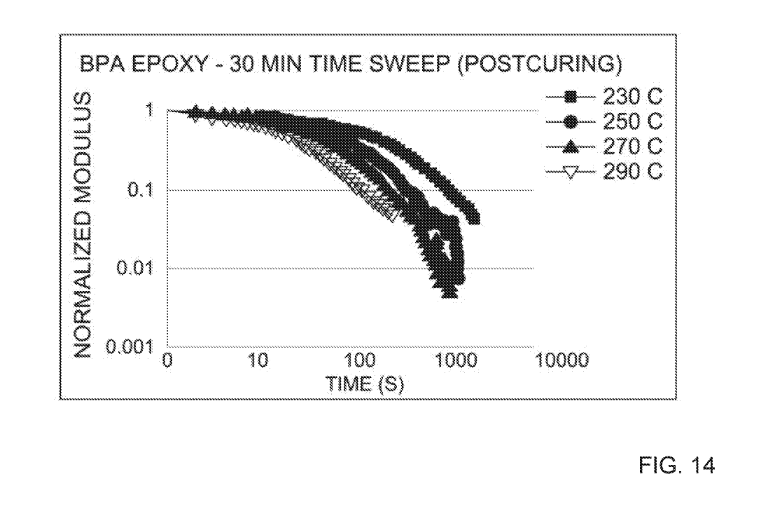

Assessment of the effect on post-curing was also performed. FIGS. 14 and 15 present the stress relaxation of the 2.5 wt. % BPA epoxy and ERL epoxy cross-linking agents, respectively, prior to post-curing. FIGS. 14 and 15 present oscillatory time sweep measurements for the 2.5 wt. % BPA epoxy and ERL epoxy cross-linkers, respectively, after 30 minutes post-curing. After post-curing, characteristic dynamically cross-linked network behavior was apparent for both the BPA epoxy and ERL epoxy materials.

Additional stress relaxation curves were also observed to further examine the rheological properties of ERL epoxy compared to existing dynamically cross-linked compositions. As shown in Table 4, sample 1 was prepared as a control sample (CS1) to compare a dynamically cross-linked polymer composition with a polymeric chain extender (DER. 671). Samples 2-5 (S2-S5) were prepared at varying amounts of monomeric epoxy chain extender ERL. Table 4 also indicates the ratio of epoxy to carboxylic acid endgroups observed.

TABLE 4
Formulations at varying amounts of ERL epoxy chain extender.

| | CS1 | S2 | S3 | S4 | S5 |
|---|---|---|---|---|---|
| wt. % D.E.R. 671 | 5.3 | 0 | 0 | 0 | 0 |
| wt. % ERL 4221 | 0 | 1.1 | 1.1 | 2.2 | 3.3 |
| Wt. % Zn(II) catalyst | 0.2 | 0 | 0.3 | 0.3 | 0.3 |
| Epoxy:COOH ratio | 1.7 | 1.1 | 1.1 | 2.2 | 3.3 |

Stress relaxation curves for each sample CS1 and S2-S5 varied. Characteristic curves corresponding to dynamically cross-linked networks were apparent for CS1 and S5. CS1 and S5 exhibited the characteristically slow component and in stress relaxation corresponding to a network relaxation by transesterification reactions. Samples S3 and S4 however, having lower ERL content, or no catalyst S2, exhibited fast relaxation times (below 0.1 seconds). When the measurement began, S2-S4 were completely relaxed which is indicative of thermoplastic behavior. It is also noted that ERL generates a secondary alcohol in the presence of the suitable transesterification catalyst while D.E.R. 671 (having an epoxy ring) generates a primary alcohol.

1. A method of preparing a pre-dynamic or a dynamic cross-linked polymer composition comprising:
combining
an ester oligomer component,
a monomeric chain extender,
a transesterification catalyst, and
a polycondensation catalyst
at a temperature and for a time sufficient to form a molten mixture; and
heating the molten mixture at a polycondensation temperature and at a polycondensation pressure for a time sufficient to initiate polycondensation and to form the pre-dynamic or dynamic cross-linked polymer composition.

2. The method of claim 1, wherein the ester oligomer component has an intrinsic viscosity of between 0.09 dl/g and 0.35 dl/g.

3. The method of claim 1, wherein the ester oligomer component has a carboxylic acid endgroup concentration between 20 mmol/kg and 120 mmol/kg.

4. The method of claim 1, wherein the temperature sufficient to form the molten mixture is a temperature just below or at the melting temperature of the ester oligomer component.

5. The method of claim 1, wherein the temperature sufficient to form the molten mixture is between 230° C. and 260° C.

6. The method of claim 1, wherein the polycondensation temperature is between about 240° C. and 265° C., preferably about 260° C.

7. The method of claim 1, wherein the polycondensation pressure is a value less than atmospheric pressure at which the molten mixture was formed.

8. The method of claim 1, wherein the polycondensation pressure is maintained at less than or equal to about 1 mmHg.

9. The method of claim 1, wherein the ester oligomer component is a C2-C20 alkylene terephthalate oligomer, preferably a butylene terephthalate oligomer, a poly(ethylene terephthalate), a poly(propylene terephthalate), or any combination thereof.

10. The method of claim 1, wherein the ester oligomer component is butylene terephthalate oligomer derived from terephthalic acid.

11. The method of claim 1, wherein the transesterification catalyst is zinc(II)acetate or zinc(II) acetylacetonate.

12. The method of claim 1, wherein the transesterification catalyst is present at 0.001 wt. % to 25 wt. %, based on the number of ester groups in the ester component.

13. The method of claim 1, wherein the polycondensation catalyst is titanium(IV) isopropoxide, or a tetra-n-propyl titanate, tetraisopropyl titanate, tetra-n-butyl titanate, tetraphenyl titanate, tetracyclohexyl titanate, tetrabenzyl titanate, tetra-n-butyl titanate tetramer, titanium acetate, titanium glycolates, titanium oxalates, sodium or potassium titanates, titanium halides, titanate hexafluorides of potassium, manganese and ammonium, titanium acetylacetate, titanium alkoxides, titanate phosphites, or a combination thereof.

14. The method of claim 1, wherein the monomeric chain extender is reactive with the carboxylic acid endgroup or with the alcohol endgroup functionality of the ester oligomer component.

15. The method of claim 1, wherein the monomeric chain extender comprises a bisphenol A epoxy, a 3,4-epoxy cyclohexyl methyl-3,4-epoxy cyclohexyl carboxylate, or a pyromellitic dianhydride, or a combination thereof.

16. The method of claim 1, wherein the transesterification catalyst and the polycondensation catalyst comprise at least a portion of the same catalyst.

17. The method of claim 1, wherein the dynamic cross-linked polymer composition (a) has a plateau modulus of from about 0.01 MPa to about 1000 MPa when measured by dynamic mechanical analysis at a temperature above the melting temperature of the polyester component of the pre-dynamic cross-linked composition and (b) exhibits the capability of relaxing internal residual stresses at a characteristic timescale of between 0.1 and 100,000 seconds above the glass transition temperature of the base polymer, as measured by stress relaxation rheology measurement.

18. A method of forming an article comprising a pre-dynamic or dynamic cross-linked polymer composition comprising:
preparing a pre-dynamic or dynamic cross-linked polymer composition according to the method of claim 1; and
subjecting the pre-dynamic or dynamic cross-linked polymer to a polymer forming process, such as compression molding, profile extrusion, injection molding, or blow molding to form the article.

19. An article formed from the pre-dynamic or dynamic cross-linked polymer composition prepared according to the method of claim 1, wherein the article comprises one or more of a composite, a thermoformed material, or a combination thereof.

20. A method of preparing a dynamic cross-linked polymer composition comprising:
combining
an ester oligomer component,
a monomeric chain extender,
a transesterification catalyst, and
a polycondensation catalyst
at a temperature and for a time sufficient to form a molten mixture; and
heating the molten mixture at a polycondensation temperature and at a polycondensation pressure for a time sufficient to initiate polycondensation and to form the dynamic cross-linked polymer composition, wherein a polycondensation catalyst quencher is not combined with the ester oligomer component, monomeric chain extender, transesterification catalyst, and or polycondensation catalyst.
